(19) United States
(12) Patent Application Publication
(10) Pub. No.: US 2023/0170172 A1
(43) Pub. Date: Jun. 1, 2023

(54) HERMETICALLY SEALED ELECTROMAGNETIC CONTACTOR

(71) Applicant: FUJI ELECTRIC FA COMPONENTS & SYSTEMS CO., LTD., Saitama (JP)

(72) Inventors: Takashi TSUTSUMI, Kounosu-city (JP); Koujun KONISHI, Kounosu-city (JP); Hideo ADACHI, Fukaya-city (JP)

(73) Assignee: FUJI ELECTRIC FA COMPONENTS & SYSTEMS CO., LTD., Saitama (JP)

(21) Appl. No.: 18/147,361

(22) Filed: Dec. 28, 2022

Related U.S. Application Data
(63) Continuation of application No. PCT/JP2021/044678, filed on Dec. 6, 2021.

(30) Foreign Application Priority Data
Jan. 22, 2021 (JP) 2021-008372

(51) Int. Cl. H01H 50/02; H01H 50/54; H01H 50/44

(52) U.S. Cl. CPC H01H 50/023; H01H 50/546; H01H 50/44; H01H 2050/025

(57) ABSTRACT

A hermetically sealed electromagnetic contactor includes a main contact unit (21) configured to open and close an electrical path of a main circuit by moving along a predetermined opening/closing direction, an electromagnet unit (23) configured to switch opening/closing of the main contact unit (21), a container body (12) made of resin inside which the main contact unit (21) and the electromagnet unit (23) are arranged, an auxiliary contact unit (22) disposed outside the container body (12) on one side in the opening/closing direction of the main contact unit (21) and configured to open and close an electrical path of an auxiliary circuit by moving along the opening/closing direction in conjunction with the main contact unit (21), and an auxiliary contact housing portion (13) made of resin inside which the auxiliary contact unit (22) is arranged, the auxiliary contact housing portion (13) communicating with the inside of the container body (12), in which the insides of the container body (12) and the auxiliary contact housing portion (13) are filled with insulating gas.

### TECHNICAL FIELD

The present invention relates to a hermetically sealed electromagnetic contactor.

### BACKGROUND ART

In a hermetically sealed electromagnetic contactor described in PTL 1, by housing a contact unit in a hermetically sealed container, which is made of metal and is covered by a lid made of ceramic, and filling the hermetically sealed container with pressurized insulating gas, such as hydrogen, breaking performance of the contact is improved.

### CITATION LIST

### Patent Literature

PTL 1: U.S. Pat. No. 7,944,333 B

### SUMMARY OF INVENTION

### Technical Problem

In a configuration using a hermetically sealed container, which is made of metal and is covered by a lid made of ceramic, it is difficult to lead out auxiliary terminals while securing electrical insulation and increases in the number of components and cost are brought about.

An object of the present invention is to, in a hermetically sealed electromagnetic contactor, dispose an auxiliary contact with a simpler structure at a low cost.

### Solution to Problem

A hermetically sealed electromagnetic contactor according to one aspect of the present invention includes a main contact unit configured to open and close an electrical path of a main circuit by moving along a predetermined opening/closing direction, an electromagnet unit configured to switch opening/closing of the main contact unit, a container body made of resin inside which the main contact unit and the electromagnet unit are arranged, an auxiliary contact unit disposed outside the container body on one side in the opening/closing direction of the main contact unit and configured to open and close an electrical path of an auxiliary circuit by moving along the opening/closing direction in conjunction with the main contact unit, and an auxiliary contact housing portion made of resin inside which the auxiliary contact unit is arranged, the auxiliary contact housing portion communicating with the inside of the container body, in which the insides of the container body and the auxiliary contact housing portion are filled with insulating gas.

### Advantageous Effects of Invention

According to the present invention, employing a container body and an auxiliary contact housing portion made of resin enables an auxiliary contact housing portion to be easily disposed on one side in the opening/closing direction in the container body, while enabling electrical insulation to be secured. As described above, it is possible to dispose an auxiliary contact with a simpler structure at a low cost.

### BRIEF DESCRIPTION OF DRAWINGS

FIG. 1 is an external view of a hermetically sealed container (a first embodiment);

FIG. 2 is an exploded view of the hermetically sealed container (the first embodiment);

FIG. 3 is a cross-sectional view of the hermetically sealed container (the first embodiment);

FIG. 4 is another cross-sectional view of the hermetically sealed container (the first embodiment);

FIG. 5 is a cross-sectional view of a coil contact piece;

FIG. 6 is a diagram illustrative of the coil contact pieces, support springs, and relay contact pieces;

FIG. 7 is an external view of a hermetically sealed container (a second embodiment);

FIG. 8 is an exploded view of the hermetically sealed container (the second embodiment);

FIG. 9 is a cross-sectional view of the hermetically sealed container (the second embodiment);

FIG. 10 is another cross-sectional view of the hermetically sealed container (the second embodiment);

FIG. 11 is a cross-sectional view of an auxiliary fixed terminal (the second embodiment);

FIG. 12 is an external view of a hermetically sealed electromagnetic contactor (a third embodiment);

FIG. 13 is an external view of a hermetically sealed container (the third embodiment);

FIG. 14 is an exploded view of the hermetically sealed container (the third embodiment);

FIG. 15 is a cross-sectional view of the hermetically sealed container (the third embodiment);

FIG. 16 is another cross-sectional view of the hermetically sealed container (the third embodiment);

FIG. 17 is a cross-sectional view of a coil contact piece (the third embodiment);

FIG. 18 is a diagram illustrative of the coil contact pieces, support springs, and relay contact pieces (the third embodiment);

FIG. 19 is a cross-sectional view of an auxiliary contact unit (the third embodiment); and

FIGS. 20A-20B are diagrams illustrative of a nut member (the third embodiment).

### DESCRIPTION OF EMBODIMENTS

Embodiments of the present invention will be described below, based on the drawings. Note that the respective drawings are schematic and do not necessarily depict the actual dimensions or precise configurations of practical implementation of the present invention. In addition, the following embodiments indicate a device and a method to embody the technical idea of the present invention by way of example, and do not limit the configuration to that described below. That is, the technical idea of the present invention can be subjected to a variety of alterations within the technical scope described in CLAIMS.

### First Embodiment

(Configuration)

In the following description, for descriptive purposes, three directions orthogonal to one another are assumed to be the vertical direction, the width direction, and the depth direction.

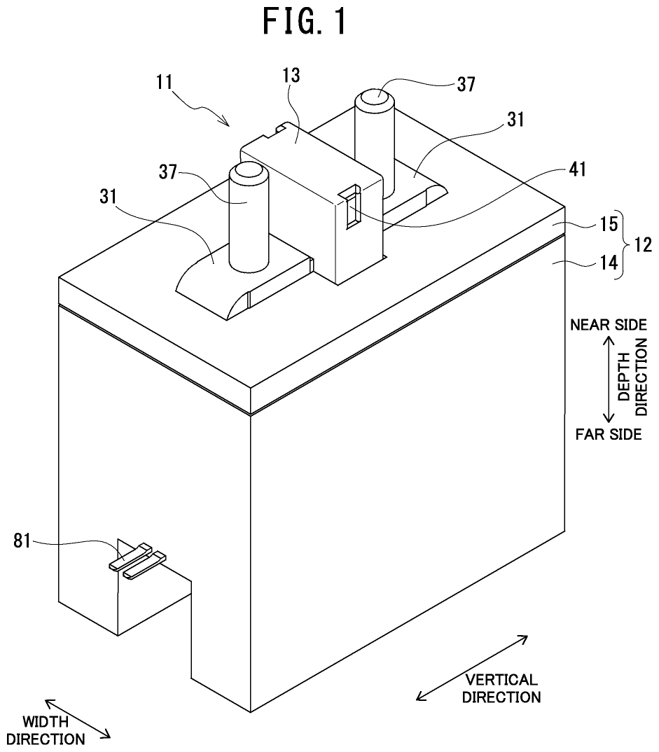

FIG. 1 is an external view of a hermetically sealed container (a first embodiment).

A hermetically sealed container 11 is used, housed in a case of a not-illustrated hermetically sealed electromagnetic contactor, and opens and closes an electrical path of a main circuit and also opens and closes an electrical path of an auxiliary circuit in an interlocking manner with opening and closing of the main circuit. The hermetically sealed container 11 is made of a resin having electrical insulation and includes a container body 12 and an auxiliary contact housing portion 13. The container body 12 includes a container portion 14 and a lid portion 15.

The container portion 14 is formed in a square box shape that has the far side in the depth direction, both sides in the vertical direction, and both sides in the width direction closed and the near side in the depth direction opened.

The lid portion 15 fits into the open end of the container portion 14 and closes the near side in the depth direction of the container portion 14. It is assumed that a protruding line portion and a recessed line portion are formed on one and the other of the container portion 14 and the lid portion 15, respectively and the protruding line portion and the recessed line portion are fitted to each other.

The auxiliary contact housing portion 13 is disposed at the center of the lid portion 15, is formed in a square small-box shape that has the near side in the depth direction, both sides in the vertical direction, and both sides in the width direction closed and the far side in the depth direction opened, and communicates with the inside of the container body 12.

The hermetically sealed container 11 is filled with pressurized insulating gas, such as hydrogen and nitrogen. Therefore, the hermetically sealed container 11 not only has the container portion 14, the lid portion 15, and the auxiliary contact housing portion 13 fixed to each other with epoxy resin-based adhesive, but also has gas barrier coating applied to the entire outer peripheral surface including boundary portions, using laminated films of clay crystals. Specifically, exchanging interlayer ions in purified smectite and joining the laminated films with an organic binder, such as polyvinyl alcohol (PVA) and water-soluble nylon, causes the laminated films to exhibit labyrinth effect and thereby prevent permeation of gas molecules, such as hydrogen and nitrogen. The laminated films are stacked in the thickness direction, and the thickness thereof is, for example, 2 μm. The gas barrier coating is applied by a spray method in which coating liquid is formed into mist and applied to the hermetically sealed container 11, and is completed by being burned at a temperature at which interlayer ions are incorporated into clay crystals, for example, a temperature greater than or equal to 150° C. Since, as described above, gas barrier coating is applied to the entire outer peripheral surface, the outer peripheral shape of the hermetically sealed container 11 is preferably formed in a polygon that is composed of planes that are flat and linear to the extent possible.

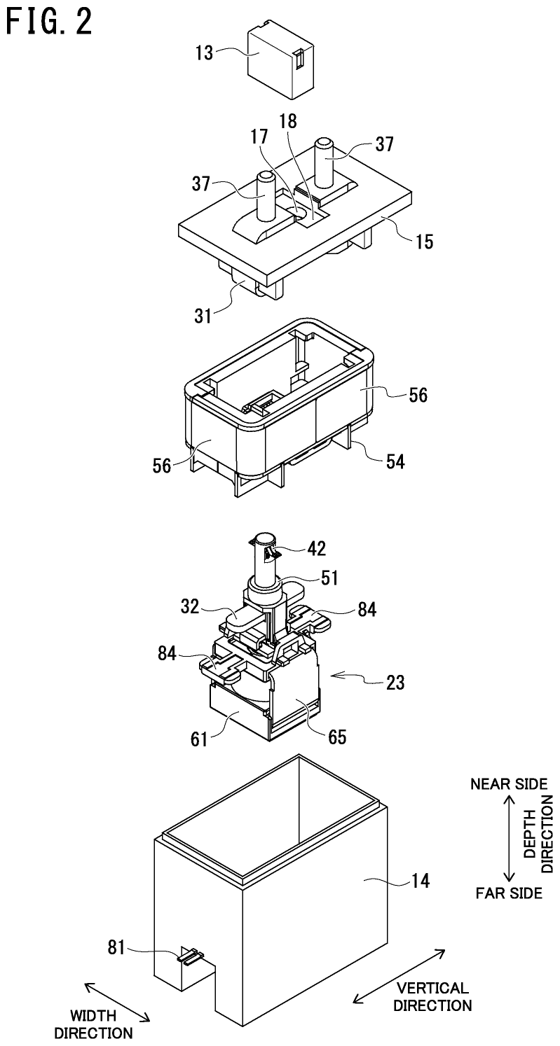

FIG. 2 is an exploded view of the hermetically sealed container (the first embodiment).

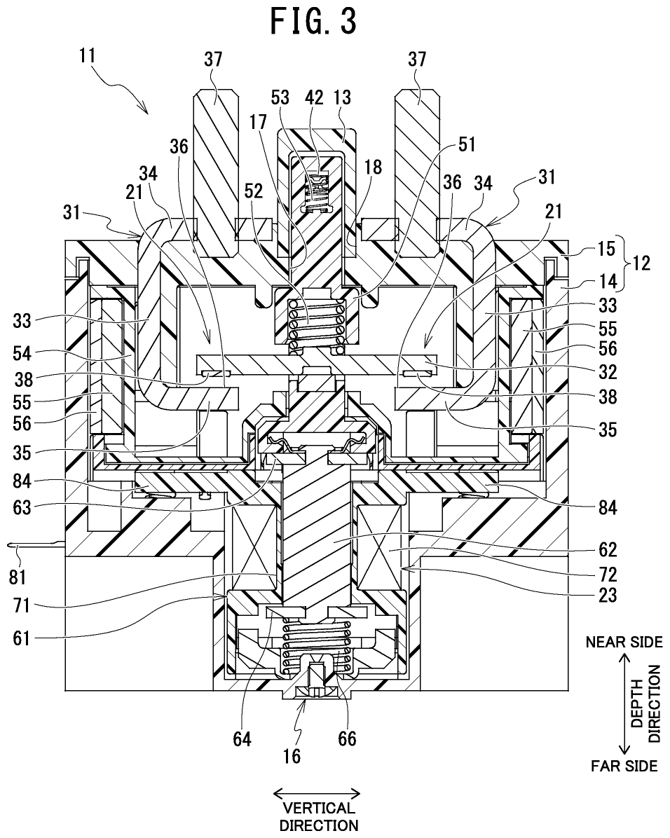

FIG. 3 is a cross-sectional view of the hermetically sealed container (the first embodiment).

In this drawing, a cross section passing the center in the width direction and taken along the vertical direction and the depth direction is illustrated.

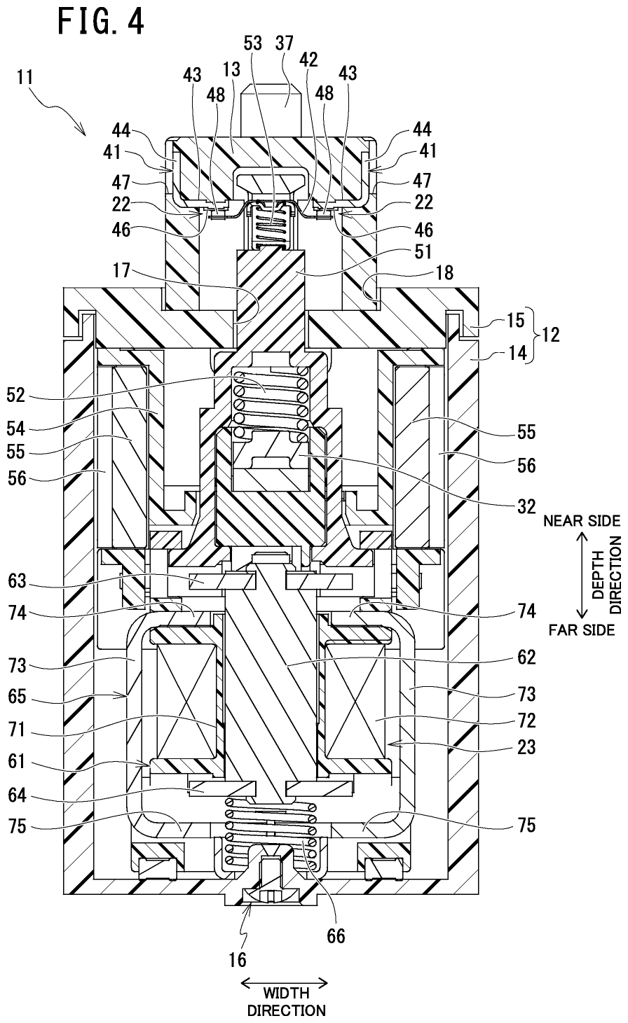

FIG. 4 is another cross-sectional view of the hermetically sealed container (the first embodiment).

In this drawing, a cross section passing the center in the vertical direction and taken along the width direction and the depth direction is illustrated.

In the hermetically sealed container 11, a main contact unit 21, an auxiliary contact unit 22, and an electromagnet unit 23 are housed. Specifically, the auxiliary contact unit 22 is arranged in the auxiliary contact housing portion 13, the main contact unit 21 is arranged on the near side in the depth direction in the container body 12, and the electromagnet unit 23 is arranged on the far side in the depth direction in the container body 12. In the container portion 14, a gas filling structure 16 for filling of the hermetically sealed container 11 with insulating gas is formed at the center of the bottom surface.

The main contact unit 21 is a contact unit connected to a main circuit via crimp terminals and configured to open and close an electrical path of the main circuit, and the container body 12 includes a pair of main fixed contact pieces 31 and a main movable contact piece 32.

The pair of main fixed contact pieces 31 are belt-shaped metals having conductivity and are arranged with a gap interposed therebetween in the vertical direction. Each of the main fixed contact pieces 31 includes a side plate portion 33, an upper plate portion 34, and a lower plate portion 35 and is formed in a substantially U-shape opening to the inner side in the vertical direction when viewed from the width direction. The side plate portion 33 is formed in a plate shape extending in the depth direction and aligned with the width direction and the depth direction on the outer side in the vertical direction, and penetrates through the lid portion 15. The upper plate portion 34 is formed in a plate shape aligned with the vertical direction and the width direction and extends from the near side in the depth direction of the side plate portion 33 toward the inner side in the vertical direction outside the container body 12. The lower plate portion 35 is formed in a plate shape aligned with the vertical direction and the width direction and extends from the far side in the depth direction of the side plate portion 33 toward the inner side in the vertical direction inside the container body 12.

The pair of lower plate portions 35 are disposed with a gap interposed between the tip ends thereof, which face each other in the vertical direction, inside the container body 12 and respectively have main fixed contacts 36 formed on surfaces on the near side in the depth direction. The pair of upper plate portions 34 are arranged with a gap interposed between the tip ends thereof, which face each other in the vertical direction, outside the container body 12 and are disposed in such a manner that surfaces thereof on the far side in the depth direction come into contact with the lid portion 15. In each of the pair of upper plate portions 34, a threaded hole penetrating in the depth direction is formed and a terminal bolt 37 is fitted into an internal threaded portion of the threaded hole. Each of the terminal bolts 37 is made of a metal having conductivity and is a stud bolt that does not have a head and on which an external threaded portion is formed over the entire length in the depth direction. The terminal bolt 37 has the far side in the depth direction embedded in the lid portion 15 and the near side in the depth direction, which projects out of the upper plate portion 34, serving as a main terminal portion. One and the other of the pair of terminal bolts 37 are connected to the primary side and the secondary side of the main circuit, respectively.

The pair of main fixed contact pieces 31 and terminal bolts 37 are integrated with the lid portion 15 with the side plate portions 33 penetrating through the lid portion 15 by insert molding. Specifically, after fine micron-sized protruding and recessed shapes are formed on the surfaces of the main fixed contact pieces 31 and the surfaces of the terminal bolts 37 by chemical etching, insert molding is performed. Through this processing, melted resin enters the inside of the protruding and recessed shapes and solidification of the resin causes the metal and the resin to be joined at the interface level and produces complex junctions exhibiting labyrinth effect, which prevents gas molecules, such as hydrogen and nitrogen, from leaking. Examples of the metal surface treatment technology include “AMALPHA” (registered trademark) by MEC COMPANY LTD.

The main movable contact piece 32 is made of a metal having conductivity, is a long flat plate extending in the vertical direction and aligned with the vertical direction and the width direction, and is arranged on the near side in the depth direction of the pair of lower plate portions 35. That is, the pair of main fixed contact pieces 31, which are formed in substantially U-shapes, are disposed in such a manner that the openings of the substantially U-shapes face each other in the long-length direction of the main movable contact piece 32. On both end sides of the main movable contact piece 32, main movable contacts 38 are brazed on a surface on the far side in the depth direction. The main movable contact piece 32 causes the main movable contacts 38 to be respectively separated from the main fixed contacts 36 when the main movable contact piece 32 retreats to the near side in the depth direction, and causes the main movable contacts 38 to respectively come into contact with the main fixed contacts 36 when the main movable contact piece 32 advances to the far side in the depth direction. The main contact unit 21 is formed by the main fixed contacts 36 and the main movable contacts 38. Since the main movable contact piece 32 opens and closes an electrical path of the main circuit by moving in the depth direction, the depth direction serves as an opening/closing direction for the main contact unit 21.

The auxiliary contact unit 22 is a contact unit connected to an auxiliary circuit via connector terminals and configured to open and close an electrical path of the auxiliary circuit, and the auxiliary contact housing portion 13 includes a pair of auxiliary fixed contact pieces 41 and an auxiliary movable contact piece 42 (see FIG. 4).

The pair of auxiliary fixed contact pieces 41 are belt-shaped metals having conductivity and are arranged with a gap interposed therebetween in the vertical direction. Each of the auxiliary fixed contact pieces 41 includes a lower plate portion 43 and a side plate portion 44 and is formed in a substantially L-shape when viewed from the vertical direction. The lower plate portion 43 is formed in a plate shape extending in the width direction and aligned with the width direction and the vertical direction, and penetrates through a sidewall of the auxiliary contact housing portion 13. The side plate portion 44 is formed in a plate shape aligned with the vertical direction and the depth direction and extends from the outer side in the width direction of the lower plate portion 43 toward the near side in the depth direction outside the auxiliary contact housing portion 13.

The pair of lower plate portions 43 are disposed with a gap interposed between the tip ends thereof, which face each other in the width direction, inside the auxiliary contact housing portion 13 and respectively have auxiliary fixed contacts 46 brazed on surfaces on the far side in the depth direction. On the auxiliary contact housing portion 13, a recessed portion 47, which is recessed toward the inner side in the width direction, is formed on each of outer peripheral surfaces on both sides in the width direction, and the side plate portions 44 are exposed by the recessed portions 47. The pair of side plate portions 44, which are exposed by the recessed portions 47, serve as auxiliary terminal portions, and one and the other of the auxiliary terminal portions are connected to the primary side and the secondary side of the auxiliary circuit, respectively. The pair of auxiliary fixed contact pieces 41 are integrated with the auxiliary contact housing portion 13 in such a manner as to penetrate through sidewalls of the auxiliary contact housing portion 13 by insert molding. As for a method of insert molding, the same method as that used for the afore-described main fixed contact pieces 31 can be used.

The auxiliary movable contact piece 42 is made of a metal having conductivity, is a long flat plate extending in the width direction and aligned with the width direction and the vertical direction, and is arranged on the far side in the depth direction of the pair of auxiliary fixed contact pieces 41. That is, when viewed from the depth direction, the long-length directions of the main movable contact piece 32 and the auxiliary movable contact piece 42 are orthogonal to each other. Both end sides of the auxiliary movable contact piece 42 bifurcate and form dual contacts, and auxiliary movable contacts 48 are brazed on a surface on the near side in the depth direction of the auxiliary movable contact piece 42. The auxiliary movable contact piece 42 causes the auxiliary movable contacts 48 to respectively come into contact with the auxiliary fixed contacts 46 when the auxiliary movable contact piece 42 retreats to the near side in the depth direction, and causes the auxiliary movable contacts 48 to be respectively separated from the auxiliary fixed contacts 46 when the auxiliary movable contact piece 42 advances to the far side in the depth direction. The auxiliary contact unit 22 is formed by the auxiliary fixed contacts 46 and the auxiliary movable contacts 48. Since the auxiliary movable contact piece 42 opens and closes an electrical path of the auxiliary circuit by moving in the depth direction, the depth direction serves as an opening/closing direction for the auxiliary contact unit 22.

The main movable contact piece 32 and the auxiliary movable contact piece 42 are supported by a contact support 51. The contact support 51 is made of a resin having electrical insulation and is arranged between the pair of main fixed contact pieces 31. In the lid portion 15, an opening portion 17 penetrating in the depth direction is formed between the pair of upper plate portions 34. The contact support 51 has the far side in the depth direction, which serves as the base end side, elastically supporting the main movable contact piece 32 via a main contact spring 52 inside the container body 12. The main contact spring 52 maintains contact pressure of the main contact unit 21 constant by biasing the main movable contact piece 32 to the far side in the depth direction.

The contact support 51 has the near side in the depth direction, which serves as the tip end side, passing the opening portion 17 and elastically supporting the auxiliary movable contact piece 42 via an auxiliary contact spring 53 inside the auxiliary contact housing portion 13. The auxiliary contact spring 53 maintains contact pressure of the auxiliary contact unit 22 constant by biasing the auxiliary movable contact piece 42 to the near side in the depth direction.

On the lid portion 15, a recessed portion 18 that is recessed toward the far side in the depth direction and into which the far side in the depth direction of the auxiliary contact housing portion 13 can be fitted is formed between the pair of upper plate portions 34 within a surface on the near side in the depth direction. The auxiliary contact housing portion 13 covers the tip end side of the contact support 51 and hermetically seals the opening portion 17 by being fixed to the recessed portion 18.

In the container body 12, a partition wall member 54 is disposed around the contact support 51. The partition wall member 54 is made of a resin having electrical insulation and is formed in a square cylindrical shape that surrounds both sides in the vertical direction and both sides in the width direction. On the partition wall member 54, a plate-shaped permanent magnet 55 is fitted into each of surfaces on both sides in the vertical direction and surfaces on both sides in the width direction of the outer peripheral surfaces, and belt-shaped yokes 56 are further disposed over the circumference of the partition wall member 54. A pair of permanent magnets 55 arranged on both sides in the vertical direction have the inner sides in the vertical direction magnetized to the S-pole, and a pair of permanent magnets 55 arranged on both sides in the width direction have the inner sides in the width direction magnetized to the N-pole. Because of this configuration, when viewed from the depth direction, magnetic flux flowing from the respective permanent magnets 55 arranged on both sides in the vertical direction to the respective permanent magnets 55 arranged on both sides in the width direction is formed. The yokes 56 are halved at the center in the vertical direction and each of the yokes 56 is formed in a substantially U-shape opening to the inner side in the vertical direction when viewed from the depth direction, and fitting the pair of yokes 56 to each other from both sides in the vertical direction causes the yokes 56 to surround the entire circumference of the partition wall member 54 viewed from the depth direction.

The electromagnet unit 23 is housed on the far side in the depth direction in the container portion 14 and switches opening/closing of the main contact unit 21 and opening/closing of the auxiliary contact unit 22. The electromagnet unit 23 includes a spool 61, a plunger 62, an upper armature 63, a lower armature 64, yokes 65, and a return spring 66 (see FIG. 4).

The spool 61 is made of a resin having electrical insulation, and a coil 72 is wound around a cylindrical winding shaft 71, which extends in the depth direction. The plunger 62 is a columnar movable iron core, which extends in the depth direction, and is inserted into the winding shaft 71. The plunger 62 has the near side in the depth direction coupled to the contact support 51 via a plate spring. The upper armature 63 is a flat plate-shaped yoke aligned with the vertical direction and the width direction and is fixed to the near side in the depth direction of the plunger 62. The lower armature 64 is a flat plate-shaped yoke aligned with the vertical direction and the width direction and is fixed to the far side in the depth direction of the plunger 62.

The pair of yokes 65 are plate-shaped yokes, and each of the yokes 65 is fixed to one of one side and the other side in the width direction of the spool 61. Each of the yokes 65 includes a side piece portion 73, an upper piece portion 74, and a lower piece portion 75 and is formed in a substantially U-shape opening to the inner side in the width direction when viewed from the vertical direction.

The side piece portion 73 is formed in a plate shape aligned with the vertical direction and the depth direction and covers the outer side in the width direction of the spool 61.

The upper piece portion 74 is formed in a plate shape aligned with the vertical direction and the width direction and extends from the near side in the depth direction of the side piece portion 73 toward the inner side in the width direction.

The lower piece portion 75 is formed in a plate shape aligned with the vertical direction and the width direction and extends from the far side in the depth direction of the side piece portion 73 toward the inner side in the width direction.

Separation distance between the upper piece portion 74 and the lower piece portion 75 is the same as separation distance between the upper armature 63 and the lower armature 64. The upper piece portion 74 is disposed on the far side in the depth direction of the upper armature 63, and the lower piece portion 75 is disposed on the far side in the depth direction of the lower armature 64.

The return spring 66 is sandwiched between the lower armature 64 and the bottom surface of the container portion 14 and biases the plunger 62 to the near side in the depth direction.

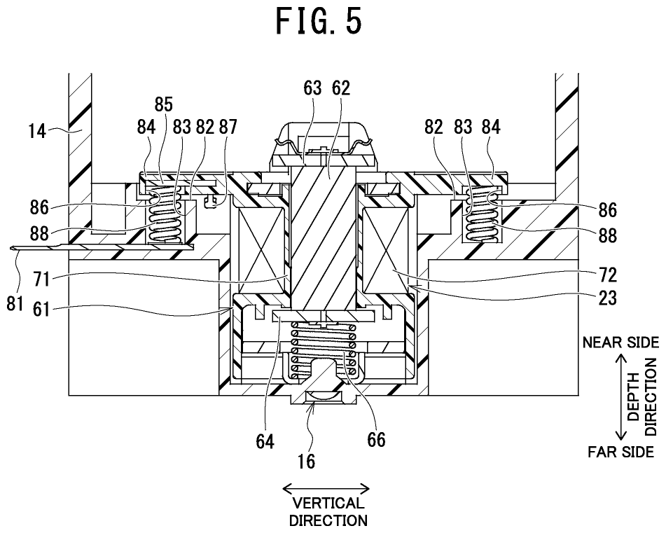

FIG. 5 is a cross-sectional view of a coil contact piece.

In this drawing, a cross section passing a coil contact piece 81 and taken along the vertical direction and the depth direction is illustrated.

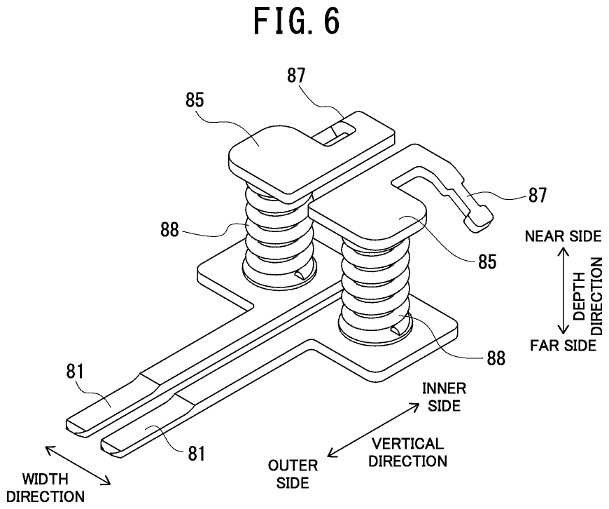

A pair of coil contact pieces 81 are made of a metal having conductivity, are formed in plate shapes aligned with the vertical direction and the width direction, and are arranged in parallel with a gap interposed therebetween in the width direction (see FIG. 6). One of the coil contact pieces 81 has the inner side in the vertical direction arranged inside the container body 12 and the outer side in the vertical direction connected to the positive side of a control circuit outside the container body 12. The other of the coil contact pieces 81 has the inner side in the vertical direction arranged inside the container body 12 and the outer side in the vertical direction connected to the negative side of the control circuit outside the container body 12. The pair of coil contact pieces 81 are integrated with the container portion 14 in such a manner as to penetrate through a sidewall of container portion 14 by insert molding. As for a method of insert molding, the same method as that used for the afore-described main fixed contact pieces 31 can be used.

On the inner peripheral surface of the container portion 14, a step-shaped spool receiving portion 82 is formed on each of both end sides in the vertical direction. On each of the spool receiving portions 82, two deep recessed portions 83, each of which is recessed toward the far side in the depth direction, are formed on a surface on the near side in the depth direction. A pair of deep recessed portions 83 are arranged in parallel with a gap interposed therebetween in the width direction, and, on one side in the vertical direction, the inner sides in the vertical direction of the coil contact pieces 81 are exposed by the deep recessed portions 83. The front surfaces of the coil contact pieces 81 that are exposed on one side in the vertical direction and the bottom surfaces of the deep recessed portions 83 formed on the other side in the vertical direction are located at the same position in the depth direction.

On the spool 61, an arm piece 84, which projects toward the outer side in the vertical direction, is formed on the near side in the depth direction and each of both sides in the vertical direction (see FIG. 3). Each of the arm pieces 84 is formed in a substantially plate shape aligned with the vertical direction and the width direction and serves as a cantilever. On one side in the vertical direction, a pair of relay contact pieces 85 are insert-molded in the arm piece 84 (see FIG. 6). The pair of relay contact pieces 85 are made of a metal having conductivity and are formed in plate shapes aligned with the vertical direction and the width direction. Since the relay contact pieces 85 are not components that penetrate through the hermetically sealed container 11, the method of insert molding does not require a special metal surface treatment technology as in a case of the afore-described main fixed contact pieces 31.

On each of the arm pieces 84, two shallow recessed portions 86, each of which is recessed toward the near side in the depth direction, are formed on a surface on the far side in the depth direction. Each pair of shallow recessed portions 86 are arranged in parallel with a gap interposed therebetween in the width direction, and, on one side in the vertical direction, the outer sides in the vertical direction of the relay contact pieces 85 are exposed by the shallow recessed portions 86. The front surfaces of the relay contact pieces 85 that are exposed on one side in the vertical direction and the bottom surfaces of the shallow recessed portions 86 formed on the other side in the vertical direction are located at the same position in the depth direction. On each of the relay contact pieces 85, a projecting portion 87, which projects from an end portion on the inner side in the vertical direction toward the outer side in the width direction, is formed (see FIG. 6). Each of the projecting portions 87 projects from a side surface in the width direction of the arm piece 84 and is inclined to the far side in the depth direction. To one of the projecting portions 87, one end of a winding wire of the coil 72 is soldered, and, to the other of the projecting portions 87, the other end of the winding wire of the coil 72 is soldered.

In each of the deep recessed portions 83 and corresponding one of the shallow recessed portions 86, a support spring 88 (spring member) is housed. Each of the support springs 88 has a feature that free height when no load is applied in the compression direction is greater than a dimension obtained by adding depth of a shallow recessed portion 86 to depth of a deep recessed portion 83. Although, when all the components are housed in the hermetically sealed container 11, a load in the compression direction is applied to the support springs 88, the support springs 88 are set to keep the arm pieces 84 separated upward from the spool receiving portion 82 even on this occasion (see FIG. 3). Therefore, the spool 61 has the pair of arm pieces 84 suspended on two pairs of support springs 88, each pair of which is disposed on one side. When the lid portion 15 is fixed to the container portion 14, the spool 61 being pressed to the lid portion 15 via the partition wall member 54 due to repulsive force of the support springs 88 causes backlash to be suppressed.

FIG. 6 is a diagram illustrative of the coil contact pieces, the support springs, and the relay contact pieces.

In this drawing, a configuration in which only the coil contact pieces 81, the relay contact pieces 85, and the support springs 88 are picked out and the container portion 14, the arm pieces 84, and the spool receiving portions 82 are omitted is illustrated. The support springs 88 are made of a metal having conductivity. On one side in the vertical direction, the support springs 88 are sandwiched between the coil contact pieces 81 and the relay contact pieces 85 while being compressed, and the support springs 88 are in contact with both the coil contact pieces 81 and the relay contact pieces 85. This configuration causes the coil contact pieces 81 and the coil 72 to be electrically connected. Therefore, on the one side in the vertical direction, the support springs 88 serve as both a support of the spool 61 and an electrical connection for the coil contact pieces 81.

According to the above description, when the coil 72 is in a non-excited state in which no current is applied to the coil 72, the plunger 62 has retreated to the near side in the depth direction due to repulsive force of the return spring 66 and, in association therewith, the contact support 51 also retreats to the near side in the depth direction. Because of this configuration, the main contact unit 21 is opened and, at the same time, the auxiliary contact unit 22 is closed. On this occasion, the upper armature 63 is separated from the upper piece portions 74, and the lower armature 64 is separated from the lower piece portions 75.

When, while the coil 72 is in this state, current is applied to the coil 72 and the coil 72 is excited, the upper armature 63 is attracted and stuck to the upper piece portions 74 and, at the same time, the lower armature 64 is attracted and stuck to the lower piece portions 75. Therefore, the plunger 62 advances to the far side in the depth direction against the repulsive force of the return spring 66 and, in association therewith, the contact support 51 also advances to the far side in the depth direction. Because of this configuration, the main contact unit 21 is closed and, at the same time, the auxiliary contact unit 22 is opened.

### Advantageous Effects

Next, main advantageous effects of the first embodiment will be described.

Although hermetically sealed containers, which house a main contact unit and an auxiliary contact unit, have been hitherto containers made of metal and covered by a lid made of ceramic, it has been difficult to lead out auxiliary terminals while maintaining electrical insulation and increases in the number of components and cost have been brought about. Accordingly, in the present embodiment, first, the main contact unit 21 and the electromagnet unit 23 are arranged inside the container body 12 that is made of resin. Further, the auxiliary contact unit 22 is disposed outside the container body 12 on the near side in the depth direction of the main contact unit 21, and the auxiliary contact unit 22 is arranged inside the auxiliary contact housing portion 13, which is made of resin and communicates with the inside of the container body 12. The insides of the container body 12 and the auxiliary contact housing portion 13 are filled with insulating gas. Employing the container body 12 and the auxiliary contact housing portion 13 that are made of resin as described above enables the auxiliary contact housing portion 13 to be easily disposed on one side in the opening/closing direction of the container body 12, while enabling electrical insulation to be secured. Therefore, it is possible to dispose an auxiliary contact with a simpler structure at a low cost.

To the container body 12 and the auxiliary contact housing portion 13, gas barrier coating is applied using laminated films of clay crystals. This configuration can suppress permeation of gas molecules, such as hydrogen and nitrogen, and thereby prevent leakage of pressurized insulating gas.

In the container body 12, the opening portion 17 is formed on the near side in the depth direction. The contact support 51, which is capable of advancing and retreating in the depth direction, has the base end side supporting the movable side of the main contact unit 21 inside the container body 12 and the tip end side passing the opening portion 17 and supporting the movable side of the auxiliary contact unit 22 inside the auxiliary contact housing portion 13. Disposing the opening portion 17 on a line along which the contact support 51 advances and retreats and causing the tip end side of the contact support 51 to enter the inside of the auxiliary contact housing portion 13 via the opening portion 17 as described above enable a structure that is easy to assemble and is inexpensive to be achieved.

The auxiliary contact housing portion 13 covers the tip end side of the contact support 51 and hermetically seals the opening portion 17. Hermetically sealing the container body 12 and the auxiliary contact housing portion 13 as described above enables breaking performance of the main contact unit 21 and the auxiliary contact unit 22 to be improved. Therefore, it is possible to prevent an arc-extinguishing space from becoming larger in size and achieve miniaturization and weight reduction.

The auxiliary contact housing portion 13 is bonded to the recessed portion 18 of the lid portion 15 by epoxy resin-based adhesive. Using adhesive for bonding between the lid portion 15 and the auxiliary contact housing portion 13 as described above enables a structure that is easy to assemble and is inexpensive to be achieved.

The main contact unit 21 includes the pair of main fixed contact pieces 31 and the main movable contact piece 32. The main fixed contact pieces 31 have the main fixed contacts 36 at one ends, and the terminal bolts 37 at the other ends serve as main terminal portions to be connected to the main circuit. The main movable contact piece 32 has the pair of main movable contacts 38, which come into contact with and are separated from the main fixed contacts 36. The auxiliary contact unit 22 includes the pair of auxiliary fixed contact pieces 41 and the auxiliary movable contact piece 42. The pair of auxiliary fixed contact pieces 41 have the auxiliary fixed contacts 46 at one ends, and the side plate portions 44 at the other ends serve as auxiliary terminal portions to be connected to the auxiliary circuit. The auxiliary movable contact piece 42 has the pair of auxiliary movable contacts 48, which come into contact with and are separated from the auxiliary fixed contacts 46. The main movable contact piece 32 and the auxiliary movable contact piece 42 are long flat plates and have the main movable contacts 38 and the auxiliary movable contacts 48 at both ends in the long-length direction, respectively. This configuration enables opening/closing of the main contact unit 21 and opening/closing of the auxiliary contact unit 22 to be easily switched.

The pair of auxiliary fixed contact pieces 41 are arranged with a gap interposed between one end sides thereof inside the auxiliary contact housing portion 13, the auxiliary fixed contact 46 is formed on one end side of each of the auxiliary fixed contact pieces 41, and the other end side of each of the auxiliary fixed contact pieces 41 is connected to the auxiliary circuit outside the auxiliary contact housing portion 13. The auxiliary movable contact piece 42 has the auxiliary movable contacts 48 formed on both end sides and causes the auxiliary movable contacts 48 to respectively come into contact with and be separated from the auxiliary fixed contacts 46. The auxiliary contact unit 22 is formed by the auxiliary fixed contacts 46 and the auxiliary movable contacts 48. The pair of auxiliary fixed contact pieces 41 are subjected to surface treatment by chemical etching and are integrated with the auxiliary contact housing portion 13 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 31 are arranged with a gap interposed between one end sides thereof inside the container body 12, the main fixed contact 36 is formed on one end side of each of the main fixed contact pieces 31, and the other end side of each of the main fixed contact pieces 31 is connected to the main circuit outside the container body 12. The main movable contact piece 32 has the main movable contacts 38 formed on both end sides and causes the main movable contacts 38 to respectively come into contact with and be separated from the main fixed contacts 36. The main contact unit 21 is formed by the main fixed contacts 36 and the main movable contacts 38. The pair of main fixed contact pieces 31 are subjected to surface treatment by chemical etching and are integrated with the lid portion 15 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 31 are formed in substantially U-shapes and are disposed in such a manner that the openings of the substantially U-shapes face each other in the long-length direction of the main movable contact piece 32. This configuration enables the hermetically sealed container 11 to be prevented from becoming larger in size in the vertical direction. Since, when the main contact unit 21 is closed, the main movable contact piece 32 pulls the main fixed contact pieces 31 to the far side in the depth direction, strength is secured by disposing the pair of upper plate portions 34 in such a manner that the upper plate portions 34 come into contact with the upper surface of the lid portion 15. Therefore, a large space within the upper surface of the lid portion 15 is used by the pair of upper plate portions 34, and it is thus difficult to secure a sufficient space in the vertical direction between the upper plate portions 34. Thus, the main movable contact piece 32 and the auxiliary movable contact piece 42 are arranged in such a manner that the long-length directions thereof are orthogonal to each other when viewed from the depth direction, and the auxiliary movable contact piece 42 is arranged in such a manner that the long-length direction thereof is parallel with the width direction of the hermetically sealed container 11. This configuration enables an interspace between the upper plate portions 34, which is limited to a small space, to be effectively used and the auxiliary contact unit 22 and the auxiliary contact housing portion 13 to be easily arranged.

Each of the coil contact pieces 81 has one end side arranged inside the container body 12 and the other end side connected to the control circuit outside the container body 12. The relay contact pieces 85 are fixed to the spool 61 of the electromagnet unit 23, and the coil 72 of the electromagnet unit 23 is connected to the relay contact pieces 85. The support springs 88 are made of metal and are sandwiched between the coil contact pieces 81 and the relay contact pieces 85 inside the container body 12. Because of this configuration, it is possible to maintain an excellent contact state between the coil contact pieces 81 and the relay contact pieces 85 by expansion and contraction of the support springs 88 even in an environment in which the electromagnetic contactor is vibrated, which enables reliability of the product to be improved. The coil contact pieces 81 are subjected to surface treatment by chemical etching and are integrated with the container portion 14 by insert molding. This processing causes the metal and the resin to be joined at the interface level and produces complex junctions exhibiting labyrinth effect, which enables gas molecules, such as hydrogen and nitrogen, to be prevented from leaking.

The support springs 88 press the electromagnet unit 23 to the container body 12. Specifically, when the lid portion 15 is fixed to the container portion 14, the spool 61 is pressed to the back surface of the lid portion 15 via the partition wall member 54 due to repulsive force of the support springs 88. This configuration can prevent backlash from occurring to the electromagnet unit 23 and the partition wall member 54 inside the container body 12. Two support springs 88 on one side and two support springs 88 on the other side in the vertical direction, that is, in total, four support springs 88 are disposed, and are arranged in such a way that repulsive force equally acts on both sides in the vertical direction of the spool 61. Because of this configuration, deviation of the center of gravity is reduced and stability is improved. In addition, workability when the container body 12 is assembled is also improved.

Note that, differing from alternating current in which current zero crossing periodically occurs, in breaking of direct current in which no current zero crossing occurs, it is required to forcibly generate current zero crossing by increasing arc voltage, which is generated between the contacts of the main contact unit 21, to a voltage greater than or equal to power source voltage and restore insulation between the contacts. Thus, by stretching an arc to an arc-extinguishing space using the permanent magnets 55 in order to increase arc voltage, it is possible to improve breaking performance. Further, by arranging the main contact unit 21 and the auxiliary contact unit 22 in the hermetically sealed container 11 and filling the inside of the hermetically sealed container 11 with insulating gas, which improves breaking performance, it is possible to prevent the arc-extinguishing space from becoming larger in size.

(Variations)

Although, in the first embodiment, it is assumed that the auxiliary contact unit 22 is a b-contact of the normally-closed type, the present invention is not limited thereto, and the auxiliary contact unit 22 may be an a-contact of the normally-open type.

Although, in the first embodiment, gas barrier coating is applied only to the outer peripheral surface of the hermetically sealed container 11, the present invention is not limited thereto, and gas barrier coating may also be applied to the inner peripheral surface of the hermetically sealed container 11.

Although, in the first embodiment, the support springs 88 serve as both a support of the spool 61 and an electrical connection for the coil contact pieces 81, the present invention is not limited thereto. That is, the roles may be separated by disposing a spring member to support the spool 61 and a spring member to electrically connect the coil contact pieces 81.

Although, in the first embodiment, the pair of permanent magnets 55 arranged on both sides in the vertical direction are arranged in such a manner as to have the inner sides in the vertical direction magnetized to the S-pole and the pair of permanent magnets 55 arranged on both sides in the width direction are arranged in such a manner as to have the inner sides in the width direction magnetized to the N-pole, the present invention in not limited thereto. Both the pair of permanent magnets 55 arranged on both sides in the vertical direction and the pair of permanent magnets 55 arranged on both sides in the width direction may be arranged in such a manner as to have the inner sides magnetized to the same pole.

### Second Embodiment

(Configuration)

Although a second embodiment is an embodiment in which the shape of a main fixed contact piece and the shape of an auxiliary fixed contact piece are changed, since a basic structure and functions are the same as those in the afore-described first embodiment, the same reference signs are assigned to the same constituent components as those in the first embodiment and detailed description thereof will be omitted.

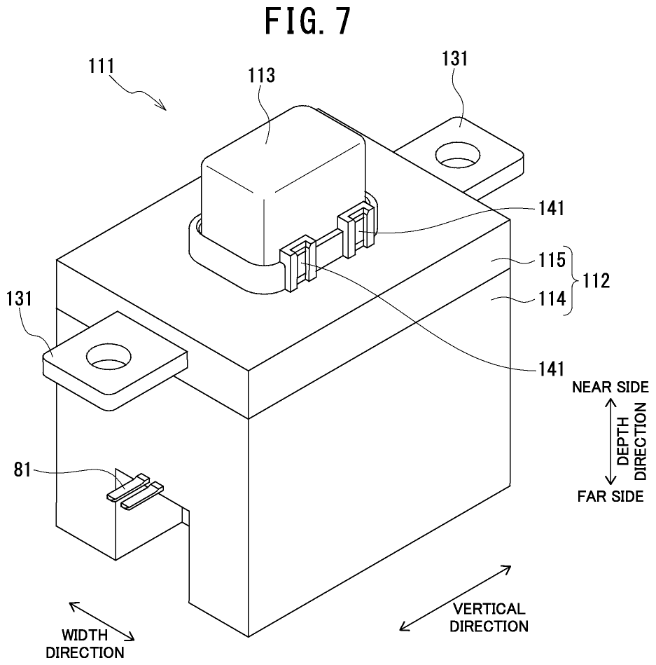

FIG. 7 is an external view of a hermetically sealed container (the second embodiment).

A hermetically sealed container 111 is used, housed in a case of a not-illustrated hermetically sealed electromagnetic contactor, and opens and closes an electrical path of a main circuit and also opens and closes an electrical path of an auxiliary circuit in an interlocking manner with opening and closing of the main circuit. The hermetically sealed container 111 is made of a resin having electrical insulation and includes a container body 112 and an auxiliary contact housing portion 113. The container body 112 includes a container portion 114 and a lid portion 115.

The container portion 114 is formed in a square box shape that has the far side in the depth direction, both sides in the vertical direction, and both sides in the width direction closed and the near side in the depth direction opened.

The lid portion 115 fits into the open end of the container portion 114 and closes the near side in the depth direction of the container portion 114. It is assumed that a protruding line portion and a recessed line portion are formed on one and the other of the container portion 114 and the lid portion 115, respectively and the protruding line portion and the recessed line portion are fitted to each other.

The auxiliary contact housing portion 113 is disposed at the center of the lid portion 115, is formed in a square small-box shape that has the near side in the depth direction, both sides in the vertical direction, and both sides in the width direction closed and the far side in the depth direction opened, and communicates with the inside of the container body 112.

The hermetically sealed container 111 is filled with pressurized insulating gas, such as hydrogen. Therefore, the hermetically sealed container 111 not only has the container portion 114, the lid portion 115, and the auxiliary contact housing portion 113 fixed to each other with epoxy resin-based adhesive, but also has gas barrier coating applied to the entire outer peripheral surface, using laminated films of clay crystals.

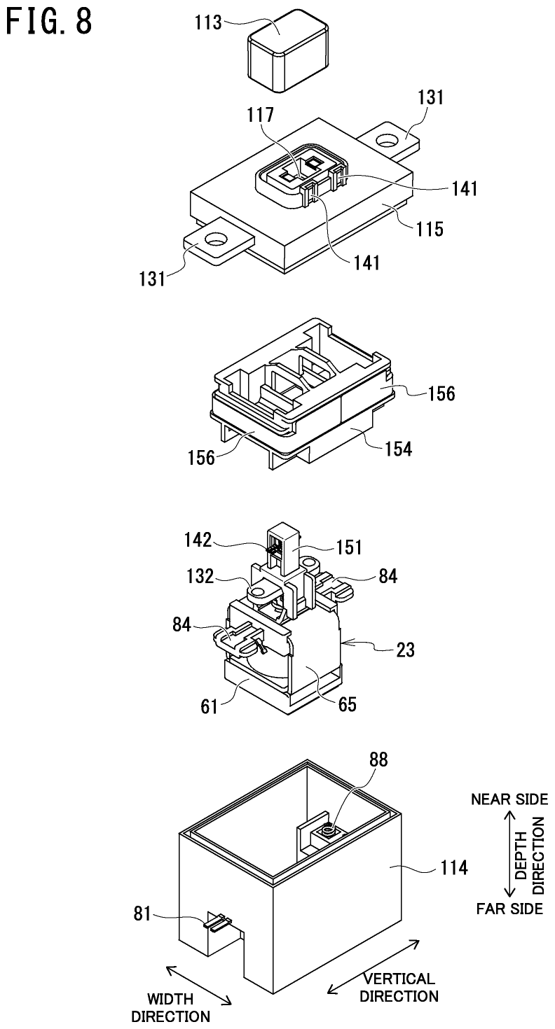

FIG. 8 is an exploded view of the hermetically sealed container (the second embodiment).

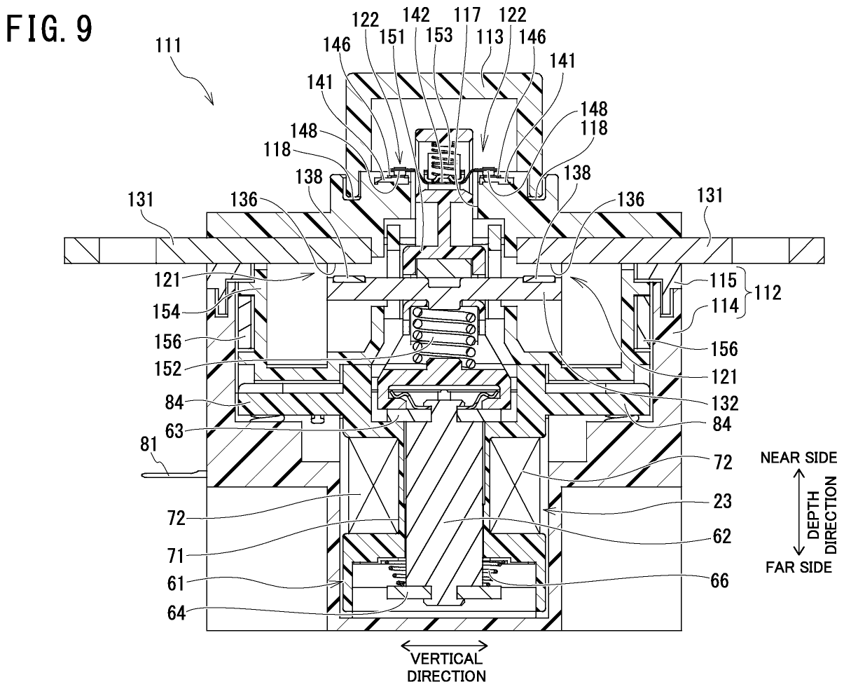

FIG. 9 is a cross-sectional view of the hermetically sealed container (the second embodiment).

In this drawing, a cross section passing the center in the width direction and taken along the vertical direction and the depth direction is illustrated.

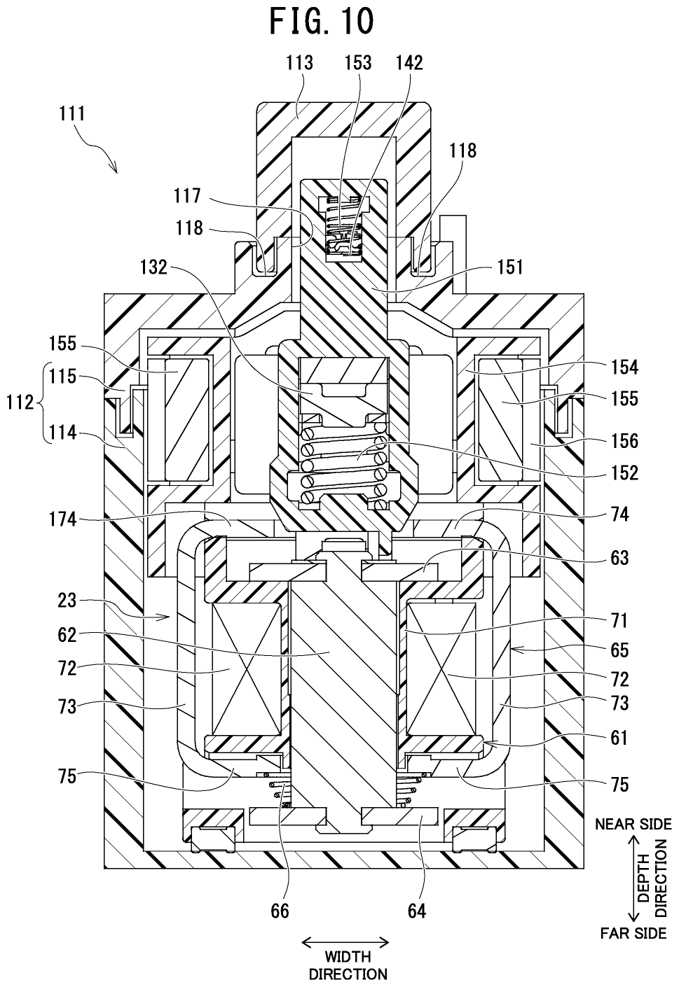

FIG. 10 is another cross-sectional view of the hermetically sealed container (the second embodiment).

In this drawing, a cross section passing the center in the vertical direction and taken along the width direction and the depth direction is illustrated.

In the hermetically sealed container 111, a main contact unit 121, an auxiliary contact unit 122, and an electromagnet unit 23 are housed. Specifically, the auxiliary contact unit 122 is arranged in the auxiliary contact housing portion 113, the main contact unit 121 is arranged on the near side in the depth direction in the container body 112, and the electromagnet unit 23 is arranged on the far side in the depth direction in the container body 112.

The main contact unit 121 is a contact unit connected to a main circuit via through bolts and configured to open and close an electrical path of the main circuit, and the container body 112 includes a pair of main fixed contact pieces 131 and a main movable contact piece 132.

The pair of main fixed contact pieces 131 are made of a metal having conductivity, are long flat plates extending in the vertical direction and aligned with the vertical direction and the width direction, and are arranged in series with a gap interposed therebetween in the vertical direction. One end sides of the pair of main fixed contact pieces 131, which are the sides facing each other, are arranged inside the container body 112, and main fixed contacts 136 are respectively formed on surfaces on the far side in the depth direction of the main fixed contact pieces 131. The other end sides of the pair of main fixed contact pieces 131, which are the sides turning away from each other, are arranged outside the container body 112 and serve as main terminal portions. One and the other of the pair of main fixed contact pieces 131 are connected to the primary side and the secondary side of the main circuit, respectively.

The pair of main fixed contact pieces 131 are integrated with the lid portion 115 in such a manner as to penetrate through sidewalls of the lid portion 115 by insert molding. Specifically, after fine micron-sized protruding and recessed shapes are formed on the surfaces of the main fixed contact pieces 131 by chemical etching, insert molding is performed. Through this processing, melted resin enters the inside of the protruding and recessed shapes and solidification of the resin causes the metal and the resin to be joined at the interface level and produces complex junctions exhibiting labyrinth effect, which prevents gas molecules, such as hydrogen and nitrogen, from leaking. As for a method of insert molding, the same method as that used for the main fixed contact pieces 31 in the afore-described first embodiment can be used.

The main movable contact piece 132 is made of a metal having conductivity, is a long flat plate extending in the vertical direction and aligned with the vertical direction and the width direction, and is arranged on the far side in the depth direction of the pair of main fixed contact pieces 131. On both end sides of the main movable contact piece 132, main movable contacts 138 are brazed on a surface on the near side in the depth direction. The main movable contact piece 132 causes the main movable contacts 138 to be respectively separated from the main fixed contacts 136 when the main movable contact piece 132 retreats to the far side in the depth direction, and causes the main movable contacts 138 to respectively come into contact with the main fixed contacts 136 when the main movable contact piece 132 advances to the near side in the depth direction. The main contact unit 121 is formed by the main fixed contacts 136 and the main movable contacts 138. Since the main movable contact piece 132 opens and closes an electrical path of the main circuit by moving in the depth direction, the depth direction serves as an opening/closing direction for the main contact unit 121.

The auxiliary contact unit 122 is a contact unit connected to an auxiliary circuit via connector terminals and configured to open and close an electrical path of the auxiliary circuit, and the auxiliary contact housing portion 113 includes a pair of auxiliary fixed contact pieces 141 and an auxiliary movable contact piece 142.

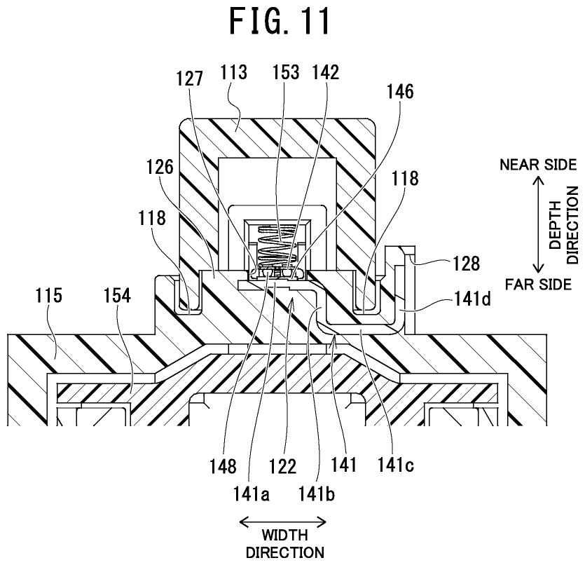

FIG. 11 is a cross-sectional view of an auxiliary fixed terminal (the second embodiment).

In this drawing, a cross section passing an auxiliary fixed contact piece 141 and taken along the vertical direction and the depth direction is illustrated.

The pair of auxiliary fixed contact pieces 141 are belt-shaped metals having conductivity and are arranged with a gap interposed therebetween in the vertical direction. Each of the auxiliary fixed contact pieces 141 includes an upper plate portion 141a, an inner-side plate portion 141b, a lower plate portion 141c, and an outer-side plate portion 141d and is formed in a substantially scoop-shape when viewed from the vertical direction.

The upper plate portion 141a is formed in a plate shape aligned with the width direction and the vertical direction and extends in the width direction. The inner-side plate portion 141b is formed in a plate shape aligned with the vertical direction and the depth direction and extends from the outer side in the width direction of the upper plate portion 141a toward the far side in the depth direction. The lower plate portion 141c is formed in a plate shape aligned with the width direction and the vertical direction and extends from the far side in the depth direction of the inner-side plate portion 141b toward the outer side in the width direction. The outer-side plate portion 141d is formed in a plate shape aligned with the vertical direction and the depth direction and extends from the outer side in the width direction of the lower plate portion 141c toward the near side in the depth direction.

On the lid portion 115, a pedestal portion 126, which bulges in order to receive the auxiliary contact housing portion 113, is formed at the center of a surface on the near side in the depth direction. On the pedestal portion 126, a recessed portion 127, which is recessed toward the far side in the depth direction, is formed on each of both sides in the vertical direction, and the upper plate portions 141a are exposed by the recessed portions 127. On each of the upper plate portions 141a, which are exposed by the recessed portions 127, an auxiliary fixed contact 146 is brazed. On the pedestal portion 126, a recessed portion 128, which is recessed toward the inner side in the width direction, is formed on each of both sides in the vertical direction within one side surface in the width direction, and the outer-side plate portions 141d are exposed by the recessed portions 128. The outer-side plate portions 141d, which are exposed by the recessed portions 128, serve as auxiliary terminal portions, and one and the other of the auxiliary terminal portions are connected to the primary side and the secondary side of the auxiliary circuit, respectively. The pair of auxiliary fixed contact pieces 141 are integrated with the pedestal portion 126 by insert molding. As for a method of insert molding, the same method as that used for the main fixed contact pieces 31 in the afore-described first embodiment can be used.

The auxiliary movable contact piece 142 is made of a metal having conductivity, is a long flat plate extending in the vertical direction and aligned with the width direction and the vertical direction, and is arranged on the far side in the depth direction of the pair of auxiliary fixed contact pieces 141 (see FIG. 9). That is, when viewed from the depth direction, the long-length directions of the main movable contact piece 132 and the auxiliary movable contact piece 142 are the same as each other. Both end sides of the auxiliary movable contact piece 142 bifurcate and form dual contacts, and auxiliary movable contacts 148 are brazed on a surface on the far side in the depth direction of the auxiliary movable contact piece 142. The auxiliary movable contact piece 142 causes the auxiliary movable contacts 148 to respectively come into contact with the auxiliary fixed contacts 146 when the auxiliary movable contact piece 142 retreats to the far side in the depth direction, and causes the auxiliary movable contacts 148 to be respectively separated from the auxiliary fixed contacts 146 when the auxiliary movable contact piece 142 advances to the near side in the depth direction. The auxiliary contact unit 122 is formed by the auxiliary fixed contacts 146 and the auxiliary movable contacts 148. Since the auxiliary movable contact piece 142 opens and closes an electrical path of the auxiliary circuit by moving in the depth direction, the depth direction serves as an opening/closing direction for the auxiliary contact unit 122.

The main movable contact piece 132 and the auxiliary movable contact piece 142 are supported by a contact support 151. The contact support 151 is made of a resin having electrical insulation and is arranged between the pair of main fixed contact pieces 131. In the lid portion 115, an opening portion 117 penetrating in the depth direction is formed between the pair of upper plate portions 141a. The contact support 151 has the far side in the depth direction, which serves as the base end side, elastically supporting the main movable contact piece 132 via a main contact spring 152 inside the container body 112. The main contact spring 152 maintains contact pressure of the main contact unit 121 constant by biasing the main movable contact piece 132 to the near side in the depth direction.

The contact support 151 has the near side in the depth direction, which serves as the tip end side, passing the opening portion 117 and elastically supporting the auxiliary movable contact piece 142 via an auxiliary contact spring 153 inside the auxiliary contact housing portion 113. The auxiliary contact spring 153 maintains contact pressure of the auxiliary contact unit 122 constant by biasing the auxiliary movable contact piece 142 to the far side in the depth direction.

On the pedestal portion 126, a recessed line portion 118 that is recessed toward the far side in the depth direction and into which the far side in the depth direction of the auxiliary contact housing portion 113 can be fitted is formed on the outer edge side when viewed from the depth direction within a surface on the near side in the depth direction. The auxiliary contact housing portion 113 covers the tip end side of the contact support 151 and hermetically seals the opening portion 117 by being fixed to the recessed line portion 118 of the pedestal portion 126.

In the container body 112, a partition wall member 154 is disposed around the contact support 151. The partition wall member 154 is made of a resin having electrical insulation and is formed in a square cylindrical shape that surrounds both sides in the vertical direction and both sides in the width direction. On the partition wall member 154, a plate-shaped permanent magnet 155 is fitted into each of surfaces on both sides in the width direction of the outer peripheral surfaces (see FIG. 10), and belt-shaped yokes 156 are further disposed over the circumference of the partition wall member 154. The pair of permanent magnets 155 arranged on both sides in the width direction have the inner sides in the width direction magnetized to the S-pole. Because of this configuration, on each of the permanent magnets 155, magnetic flux flowing from the outer side in the width direction around the outer side in the vertical direction to the inner side in the width direction is formed. The yokes 156 are halved at the center in the vertical direction and each of the yokes 156 is formed in a substantially U-shape opening to the inner side in the vertical direction when viewed from the depth direction, and fitting the pair of yokes 156 to each other from both sides in the vertical direction causes the yokes 156 to surround the entire circumference of the partition wall member 154 viewed from the depth direction.

According to the above description, when a coil 72 is in a non-excited state in which no current is applied to the coil 72, a plunger 62 has retreated to the far side in the depth direction due to repulsive force of a return spring 66 and, in association therewith, the contact support 151 also retreats to the far side in the depth direction. Because of this configuration, the main contact unit 121 is opened and, at the same time, the auxiliary contact unit 122 is closed. On this occasion, an upper armature 63 is separated from upper piece portions 74, and a lower armature 64 is separated from lower piece portions 75.

When, while the coil 72 is in this state, current is applied to the coil 72 and the coil 72 is excited, the upper armature 63 is attracted and stuck to the upper piece portions 74 and, at the same time, the lower armature 64 is attracted and stuck to the lower piece portions 75. Therefore, the plunger 62 advances to the near side in the depth direction against the repulsive force of the return spring 66 and, in association therewith, the contact support 151 also advances to the near side in the depth direction. Because of this configuration, the main contact unit 121 is closed and, at the same time, the auxiliary contact unit 122 is opened.

### Advantageous Effects

Next, main advantageous effects of the second embodiment will be described.

Although hermetically sealed containers, which house a main contact unit and an auxiliary contact unit, have been hitherto containers made of metal and covered by a lid made of ceramic, it has been difficult to lead out auxiliary terminals while maintaining electrical insulation and increases in the number of components and cost have been brought about. Accordingly, in the present embodiment, first, the main contact unit 121 and the electromagnet unit 23 are arranged inside the container body 112 that is made of resin. Further, the auxiliary contact unit 122 is disposed outside the container body 112 on the near side in the depth direction of the main contact unit 121, and the auxiliary contact unit 122 is arranged inside the auxiliary contact housing portion 113, which is made of resin and communicates with the inside of the container body 112. The insides of the container body 112 and the auxiliary contact housing portion 113 are filled with insulating gas. Employing the container body 112 and the auxiliary contact housing portion 113 that are made of resin as described above enables the auxiliary contact housing portion 113 to be easily disposed on one side in the opening/closing direction of the container body 112, while enabling electrical insulation to be secured. Therefore, it is possible to dispose an auxiliary contact with a simpler structure at a low cost.

To the container body 112 and the auxiliary contact housing portion 113, gas barrier coating is applied using laminated films of clay crystals. This configuration can suppress permeation of gas molecules, such as hydrogen and nitrogen, and thereby prevent leakage of pressurized insulating gas.

In the container body 112, the opening portion 117 is formed on the near side in the depth direction. The contact support 151, which is capable of advancing and retreating in the depth direction, has the base end side supporting the movable side of the main contact unit 121 inside the container body 112 and the tip end side passing the opening portion 117 and supporting the movable side of the auxiliary contact unit 122 inside the auxiliary contact housing portion 113. Disposing the opening portion 117 on a line along which the contact support 151 advances and retreats and causing the tip end side of the contact support 151 to enter the inside of the auxiliary contact housing portion 113 via the opening portion 117 as described above enable a structure that is easy to assemble and is inexpensive to be achieved.

The auxiliary contact housing portion 113 covers the tip end side of the contact support 151 and hermetically seals the opening portion 117. Hermetically sealing the container body 112 and the auxiliary contact housing portion 113 as described above enables breaking performance of the main contact unit 121 and the auxiliary contact unit 122 to be improved. Therefore, it is possible to prevent an arc-extinguishing space from becoming larger in size and achieve miniaturization and weight reduction.

The auxiliary contact housing portion 113 is bonded to the recessed line portion 118 of the lid portion 115 by epoxy resin-based adhesive. Using adhesive for bonding between the lid portion 115 and the auxiliary contact housing portion 113 as described above enables a structure that is easy to assemble and is inexpensive to be achieved. Since the recessed line portion 118 serves as an adhesive reservoir, adhesive can be easily injected and assembly is facilitated.

The main contact unit 121 includes the pair of main fixed contact pieces 131 and the main movable contact piece 132. The main fixed contact pieces 131 have the main fixed contacts 136 at one ends, and the other ends serve as main terminal portions to be connected to the main circuit. The main movable contact piece 132 has the pair of main movable contacts 138, which come into contact with and are separated from the main fixed contacts 136. The auxiliary contact unit 122 includes the pair of auxiliary fixed contact pieces 141 and the auxiliary movable contact piece 142. The pair of auxiliary fixed contact pieces 141 have the auxiliary fixed contacts 146 at one ends, and the outer-side plate portions 141d at the other ends serve as auxiliary terminal portions to be connected to the auxiliary circuit. The auxiliary movable contact piece 142 has the pair of auxiliary movable contacts 148, which come into contact with and are separated from the auxiliary fixed contacts 146. The main movable contact piece 132 and the auxiliary movable contact piece 142 are long flat plates and have the main movable contacts 138 and the auxiliary movable contacts 148 at both ends in the long-length direction, respectively. This configuration enables opening/closing of the main contact unit 121 and opening/closing of the auxiliary contact unit 122 to be easily switched.

The pair of auxiliary fixed contact pieces 141 are arranged with a gap interposed between one end sides thereof inside the auxiliary contact housing portion 113, the auxiliary fixed contact 146 is formed on one end side of each of the auxiliary fixed contact pieces 141, and the other end side of each of the auxiliary fixed contact pieces 141 is connected to the auxiliary circuit outside the auxiliary contact housing portion 113. The auxiliary movable contact piece 142 has the auxiliary movable contacts 148 formed on both end sides and causes the auxiliary movable contacts 148 to respectively come into contact with and be separated from the auxiliary fixed contacts 146. The auxiliary contact unit 122 is formed by the auxiliary fixed contacts 146 and the auxiliary movable contacts 148. The pair of auxiliary fixed contact pieces 141 are subjected to surface treatment by chemical etching and are integrated with the pedestal portion 126 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 131 are arranged with a gap interposed between one end sides thereof inside the container body 112, the main fixed contact 136 is formed on one end side of each of the main fixed contact pieces 131, and the other end side of each of the main fixed contact pieces 131 is connected to the main circuit outside the container body 112. The main movable contact piece 132 has the main movable contacts 138 formed on both end sides and causes the main movable contacts 138 to respectively come into contact with and be separated from the main fixed contacts 136. The main contact unit 121 is formed by the main fixed contacts 136 and the main movable contacts 138. The pair of main fixed contact pieces 131 are subjected to surface treatment by chemical etching and are integrated with the lid portion 115 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 131 are linear flat plates and are arranged in series with a gap interposed therebetween in the vertical direction. This configuration enables the hermetically sealed container 111 to be prevented from becoming larger in size in the depth direction. Since, when the main contact unit 121 is closed, the main movable contact piece 132 pushes the main fixed contact pieces 131 to the near side in the depth direction, strength is secured by disposing the pair of main fixed contact pieces 131 in such a manner that the main fixed contact pieces 131 come into contact with the ceiling surface, that is, the inner peripheral surface, of the lid portion 115. Such a layout enables a sufficient space to be secured on the upper surface of the lid portion 115. Therefore, when viewed from the depth direction, the main movable contact piece 132 and the auxiliary movable contact piece 142 can be arranged in such a manner that the long-length directions thereof are the same as each other, and the auxiliary movable contact piece 142 can be arranged in such a manner that the long-length direction thereof is parallel with the vertical direction of the hermetically sealed container 111. Employing a simple structure as described above enables competition for a space to be prevented, the auxiliary contact unit 122 and the auxiliary contact housing portion 113 to be easily arranged, and cost to be prevented from increasing.

Each of coil contact pieces 81 has one end side arranged inside the container body 112 and the other end side connected to a control circuit outside the container body 112. Relay contact pieces 85 are fixed to a spool 61 of the electromagnet unit 23, and the coil 72 of the electromagnet unit 23 is connected to the relay contact pieces 85. Support springs 88 are made of metal and are sandwiched between the coil contact pieces 81 and the relay contact pieces 85 inside the container body 112. Because of this configuration, it is possible to maintain an excellent contact state between the coil contact pieces 81 and the relay contact pieces 85 by expansion and contraction of the support springs 88 even in an environment in which the electromagnetic contactor is vibrated, which enables reliability of the product to be improved. The coil contact pieces 81 are subjected to surface treatment by chemical etching and are integrated with the container portion 114 by insert molding. This processing causes the metal and the resin to be joined at the interface level and produces complex junctions exhibiting labyrinth effect, which enables gas molecules, such as hydrogen and nitrogen, to be prevented from leaking.

The support springs 88 press the electromagnet unit 23 to the container body 112. Specifically, when the lid portion 115 is fixed to the container portion 114, the spool 61 is pressed to the pair of main fixed contact pieces 131 via the partition wall member 154 due to repulsive force of the support springs 88. This configuration can prevent backlash from occurring to the electromagnet unit 23 and the partition wall member 154 inside the container body 112. Two support springs 88 on one side and two support springs 88 on the other side in the vertical direction, that is, in total, four support springs 88 are disposed, and are arranged in such a way that repulsive force equally acts on both sides in the vertical direction of the spool 61. Because of this configuration, deviation of the center of gravity is reduced and stability is improved. In addition, workability when the container body 112 is assembled is also improved.

Other advantageous effects are the same as those in the afore-described first embodiment.

(Variations)

Although, in the second embodiment, it is assumed that the auxiliary contact unit 122 is a b-contact of the normally-closed type, the present invention is not limited thereto, and the auxiliary contact unit 122 may be an a-contact of the normally-open type.

Although, in the second embodiment, gas barrier coating is applied only to the outer peripheral surface of the hermetically sealed container 111, the present invention is not limited thereto, and gas barrier coating may also be applied to the inner peripheral surface of the hermetically sealed container 111.

Although, in the second embodiment, the support springs 88 serve as both a support of the spool 61 and an electrical connection for the coil contact pieces 81, the present invention is not limited thereto. That is, the roles may be separated by disposing a spring member to support the spool 61 and a spring member to electrically connect the coil contact pieces 81.

### Third Embodiment

(Configuration)

A third embodiment is a configuration in which a terminal screw is used as an auxiliary terminal portion.

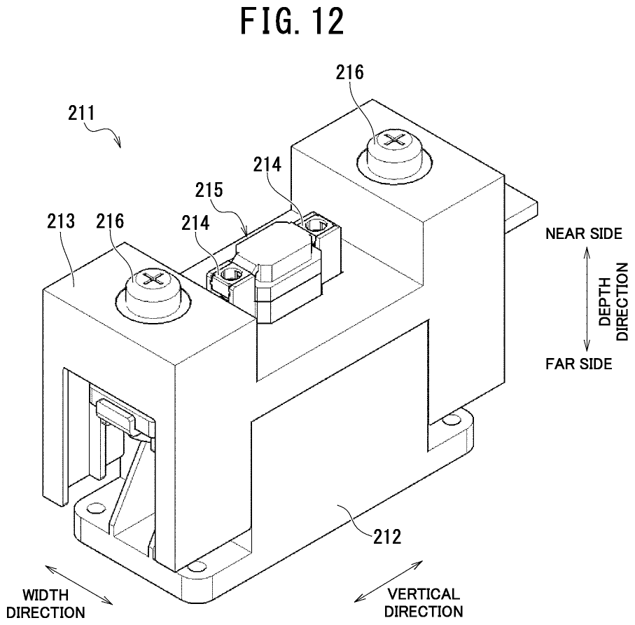

FIG. 12 is an external view of a hermetically sealed electromagnetic contactor (the third embodiment).

A hermetically sealed electromagnetic contactor 211 is of a single pole type and opens and closes an electrical path of a main circuit, and includes an auxiliary contact that opens and closes an electrical path of an auxiliary circuit in an interlocking manner with opening and closing of the main circuit. The hermetically sealed electromagnetic contactor 211 includes a case 212, a main terminal cover 213, an auxiliary terminal cover 214, and a hermetically sealed container 215 (container body).

The case 212 is made of a resin having electrical insulation and is mounted via mounting holes, which are formed at four corners on the far side in the depth direction.

The main terminal cover 213 is made of a resin having electrical insulation and, by being attached to the near side in the depth direction of the case 212 and preventing exposure of main terminals, improves safety at the time of maintenance and inspection performed by a worker. The main terminal cover 213 is formed by integrating a primary side portion and a secondary side portion, and both the primary side portion and the secondary side portion are fixed by fitting resin nuts 216 to ends of through bolts, which are fastened to main terminals. Each of the resin nuts 216 is made of a resin having electrical insulation, has the near side in the depth direction closed in a bag shape, and has a cross groove formed on a head.

The auxiliary terminal cover 214 is made of a resin having electrical insulation and, by preventing exposure of auxiliary terminals, improves safety at the time of maintenance and inspection performed by a worker. The auxiliary terminal cover 214 includes a primary side portion and a secondary side portion that are formed in separate bodies, and is fixed by being fitted to the hermetically sealed container 215.

The hermetically sealed container 215 is made of a resin having electrical insulation and is housed in and fixed to the case 212.

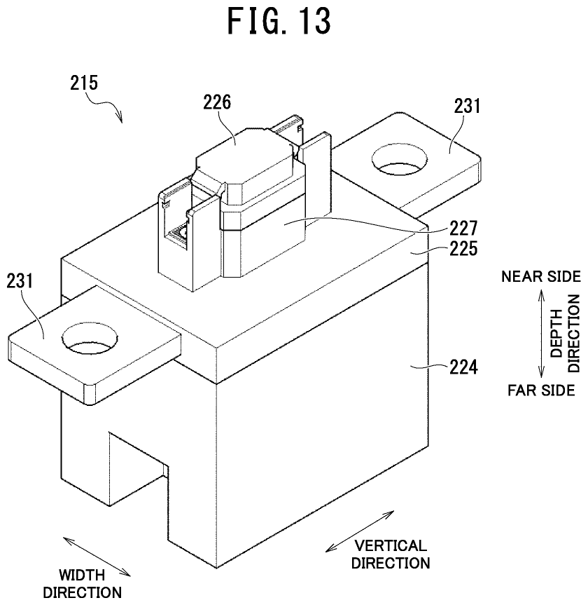

FIG. 13 is an external view of the hermetically sealed container (the third embodiment).

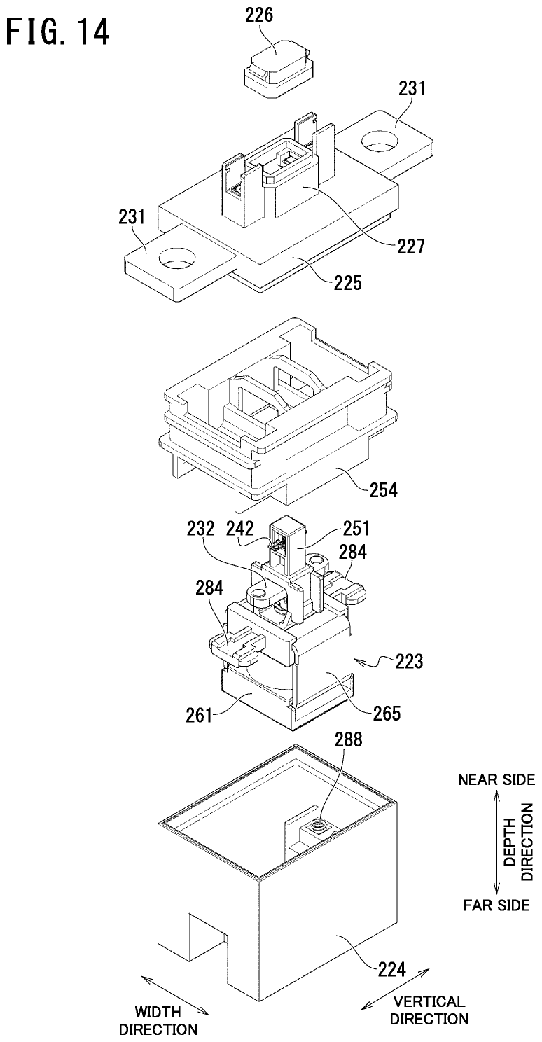

FIG. 14 is an exploded view of the hermetically sealed container (the third embodiment).

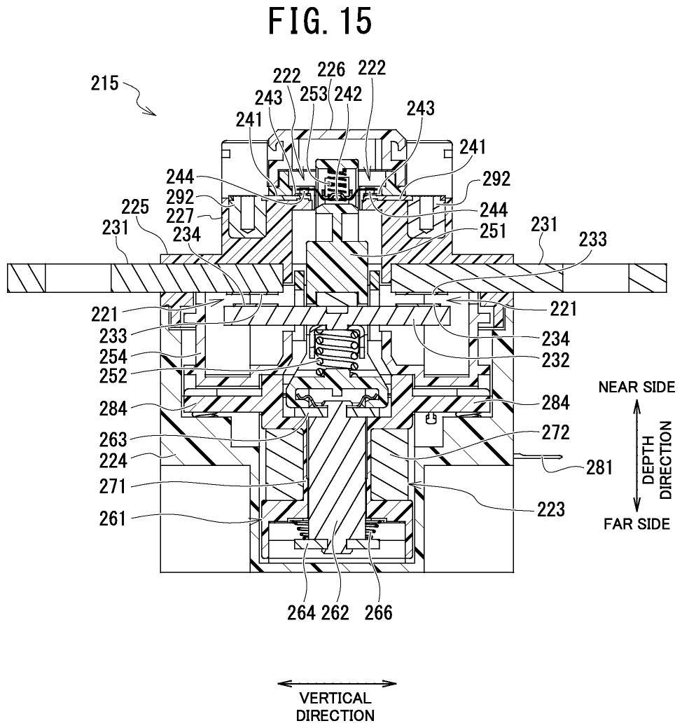

FIG. 15 is a cross-sectional view of the hermetically sealed container (the third embodiment). In this drawing, a cross section passing the center in the width direction and taken along the vertical direction and the depth direction is illustrated.

The hermetically sealed container 215 houses a main contact unit 221, an auxiliary contact unit 222, and an electromagnet unit 223 and is further filled with pressurized insulating gas, such as hydrogen and nitrogen. The hermetically sealed container 215 not only has a container portion 224, a lid portion 225, and a cap portion 226 fixed to each other with epoxy resin-based adhesive, but also has gas barrier coating applied to the entire outer peripheral surface including boundary portions, using laminated films of clay crystals. Specifically, exchanging interlayer ions in purified smectite and joining the laminated films with an organic binder, such as polyvinyl alcohol (PVA) and water-soluble nylon, causes the laminated films to exhibit labyrinth effect and thereby prevent permeation of gas molecules, such as hydrogen and nitrogen. The laminated films are stacked in the thickness direction, and the thickness thereof is, for example, 2 μm. The gas barrier coating is applied by a spray method in which coating liquid is formed into mist and applied to the hermetically sealed container 215, and is completed by being burned at a temperature at which interlayer ions are incorporated into clay crystals, for example, a temperature greater than or equal to 150° C. Since, as described above, gas barrier coating is applied to the entire outer peripheral surface, the outer peripheral shape of the hermetically sealed container 215 is preferably formed in a polygon that is composed of planes that are flat and linear to the extent possible.

The container portion 224 is formed in a square box shape that has the far side in the depth direction, both sides in the vertical direction, and both sides in the width direction closed and the near side in the depth direction opened.

The lid portion 225 fits into the open end of the container portion 224 and closes the near side in the depth direction of the container portion 224. The lid portion 225 is formed in a substantially hat-shape by a small cylinder portion 227, which protrudes toward the near side in the depth direction, being formed at the center of the lid portion 225. The small cylinder portion 227 is formed in a square cylinder shape that has the far side in the depth direction communicating with the inside of the container portion 224 and the near side in the depth direction opened.

The cap portion 226 fits into the open end of the small cylinder portion 227 and closes the near side in the depth direction of the small cylinder portion 227.

The main contact unit 221 is a contact unit connected to a main circuit via the through bolts and configured to open and close an electrical path of the main circuit, and the hermetically sealed container 215 includes a pair of main fixed contact pieces 231 and a main movable contact piece 232.

The pair of main fixed contact pieces 231 are made of a metal having conductivity, are long flat plates extending in the vertical direction and aligned with the vertical direction and the width direction, and are arranged in series with a gap interposed therebetween in the vertical direction inside the hermetically sealed container 215. On one end sides of the pair of main fixed contact pieces 231, which are the sides facing each other, main fixed contacts 233 are respectively brazed on surfaces on the far side in the depth direction. On the other end sides of the pair of main fixed contact pieces 231, which are the sides turning away from each other, main terminal portions are formed outside the hermetically sealed container 215, and one and the other of the main terminal portions are connected to the primary side and the secondary side of the main circuit, respectively.

The pair of main fixed contact pieces 231 are integrated with the lid portion 225 in such a manner as to penetrate through sidewalls of the lid portion 225 by insert molding. Specifically, after fine micron-sized protruding and recessed shapes are formed on the surfaces of the main fixed contact pieces 231 by chemical etching, insert molding is performed. Through this processing, melted resin enters the inside of the protruding and recessed shapes and solidification of the resin causes the metal and the resin to be joined at the interface level and produces complex junctions exhibiting labyrinth effect, which prevents gas molecules, such as hydrogen and nitrogen, from leaking. Examples of the metal surface treatment technology include “AMALPHA” (registered trademark) by MEC COMPANY LTD.

The main movable contact piece 232 is made of a metal having conductivity, is a long flat plate extending in the vertical direction and aligned with the vertical direction and the width direction, and is arranged on the far side in the depth direction of the pair of main fixed contact pieces 231. On both end sides of the main movable contact piece 232, main movable contacts 234 are brazed on a surface on the near side in the depth direction. The main movable contact piece 232 causes the main movable contacts 234 to be respectively separated from the main fixed contacts 233 when the main movable contact piece 232 retreats to the far side in the depth direction, and causes the main movable contacts 234 to respectively come into contact with the main fixed contacts 233 when the main movable contact piece 232 advances to the near side in the depth direction. The main contact unit 221 is formed by the main fixed contacts 233 and the main movable contacts 234.

The auxiliary contact unit 222 is a contact unit connected to an auxiliary circuit via terminal screws and configured to open and close an electrical path of the auxiliary circuit, and the hermetically sealed container 215 includes a pair of auxiliary fixed contact pieces 241 and an auxiliary movable contact piece 242.

The pair of auxiliary fixed contact pieces 241 are made of a metal having conductivity, are long flat plates extending in the vertical direction and aligned with the vertical direction and the width direction, and are arranged in series with a gap interposed therebetween in the vertical direction inside the hermetically sealed container 215. On one end sides of the pair of auxiliary fixed contact pieces 241, which are the sides facing each other, auxiliary fixed contacts 243 are respectively brazed on surfaces on the near side in the depth direction. On the other end sides of the pair of auxiliary fixed contact pieces 241, which are the sides turning away from each other, auxiliary terminal portions are formed outside the hermetically sealed container 215, and one and the other of the auxiliary terminal portions are connected to the primary side and the secondary side of the auxiliary circuit, respectively. The pair of auxiliary fixed contact pieces 241 are integrated with the small cylinder portion 227 in such a manner as to penetrate through sidewalls of the small cylinder portion 227 by insert molding. As for a method of insert molding, the same method as that used for the afore-described main fixed contact pieces 231 can be used.

The auxiliary movable contact piece 242 is made of a metal having conductivity, is a long flat plate extending in the vertical direction and aligned with the vertical direction and the width direction, and is arranged on the near side in the depth direction of the pair of auxiliary fixed contact pieces 241. That is, when viewed from the depth direction, the long-length directions of the main movable contact piece 232 and the auxiliary movable contact piece 242 are the same as each other. Both end sides of the auxiliary movable contact piece 242 bifurcate and form dual contacts, and auxiliary movable contacts 244 are brazed on a surface on the far side in the depth direction of the auxiliary movable contact piece 242. The auxiliary movable contact piece 242 causes the auxiliary movable contacts 244 to respectively come into contact with the auxiliary fixed contacts 243 when the auxiliary movable contact piece 242 retreats to the far side in the depth direction, and causes the auxiliary movable contacts 244 to be respectively separated from the auxiliary fixed contacts 243 when the auxiliary movable contact piece 242 advances to the near side in the depth direction. The auxiliary contact unit 222 is formed by the auxiliary fixed contacts 243 and the auxiliary movable contacts 244.

The main movable contact piece 232 and the auxiliary movable contact piece 242 are supported by a contact support 251. The contact support 251 is made of a resin having electrical insulation, is formed in a substantially inverted-T shape when viewed from the vertical direction, and is arranged between the pair of main fixed contact pieces 231. The contact support 251 elastically supports the main movable contact piece 232 via a main contact spring 252 on the far side in the depth direction of the main fixed contact pieces 231. The main contact spring 252 maintains contact pressure of the main contact unit 221 constant by biasing the main movable contact piece 232 to the near side in the depth direction. The contact support 251 elastically supports the auxiliary movable contact piece 242 via an auxiliary contact spring 253 on the near side in the depth direction of the auxiliary fixed contact pieces 241. The auxiliary contact spring 253 maintains contact pressure of the auxiliary contact unit 222 constant by biasing the auxiliary movable contact piece 242 to the far side in the depth direction. The contact support 251 is held by a partition wall member 254 (see FIG. 14). The partition wall member 254 is made of a resin having electrical insulation and is housed on the near side in the depth direction in the container portion 224.

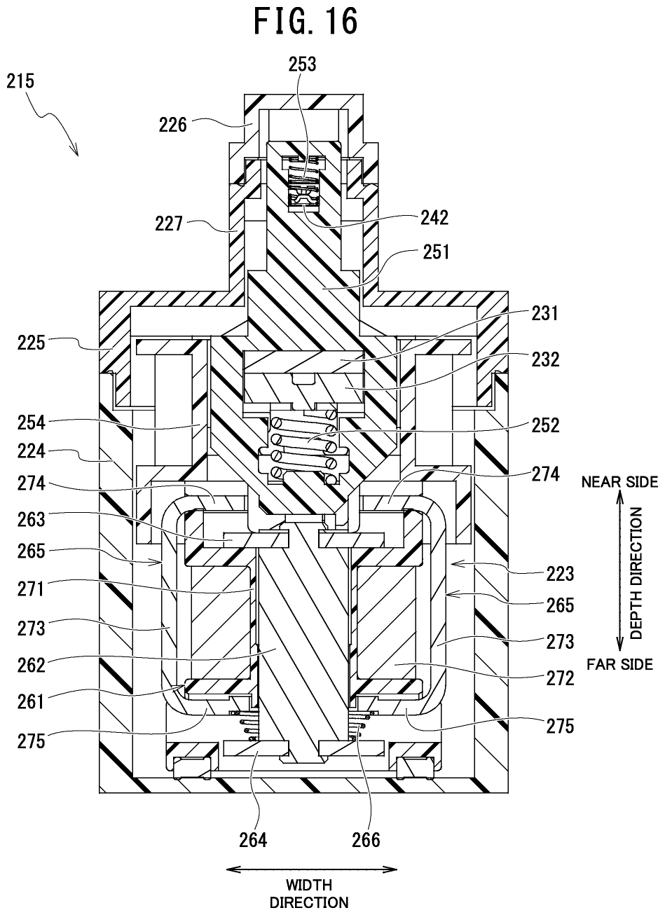

FIG. 16 is another cross-sectional view of the hermetically sealed container (the third embodiment).

In this drawing, a cross section passing the center in the vertical direction and taken along the width direction and the depth direction is illustrated.

The electromagnet unit 223 is housed on the far side in the depth direction in the container portion 224 and switches opening/closing of the main contact unit 221 and opening/closing of the auxiliary contact unit 222. The electromagnet unit 223 includes a spool 261, a plunger 262, an upper armature 263, a lower armature 264, yokes 265, and a return spring 266.

The spool 261 is made of a resin having electrical insulation, and a coil 272 is wound around a cylindrical winding shaft 271, which extends in the depth direction.

The plunger 262 is a columnar movable iron core, which extends in the depth direction, and is inserted into the winding shaft 271. The plunger 262 has the near side in the depth direction coupled to the contact support 251 via a plate spring.

The upper armature 263 is a flat plate-shaped yoke aligned with the vertical direction and the width direction and is fixed to the near side in the depth direction of the plunger 262.

The lower armature 264 is a flat plate-shaped yoke aligned with the vertical direction and the width direction and is fixed to the far side in the depth direction of the plunger 262.

The pair of yokes 265 are plate-shaped yokes, and each of the yokes 265 is fixed to one of one side and the other side in the width direction of the spool 261. Each of the yokes 265 includes a side piece portion 273, an upper piece portion 274, and a lower piece portion 275 and is formed in a substantially U-shape opening to the inner side in the width direction when viewed from the vertical direction.

The side piece portion 273 is formed in a plate shape aligned with the vertical direction and the depth direction and covers the outer side in the width direction of the spool 261.

The upper piece portion 274 is formed in a plate shape aligned with the vertical direction and the width direction and projects from the near side in the depth direction of the side piece portion 273 toward the inner side in the width direction.

The lower piece portion 275 is formed in a plate shape aligned with the vertical direction and the width direction and projects from the far side in the depth direction of the side piece portion 273 toward the inner side in the width direction.

Separation distance between the upper piece portion 274 and the lower piece portion 275 is the same as separation distance between the upper armature 263 and the lower armature 264. The upper piece portion 274 is disposed on the near side in the depth direction of the upper armature 263, and the lower piece portion 275 is disposed on the near side in the depth direction of the lower armature 264.

The return spring 266 is inserted onto the plunger 262 while being sandwiched between the lower armature 264 and the lower piece portions 275 and biases the plunger 262 to the far side in the depth direction with respect to the spool 261.

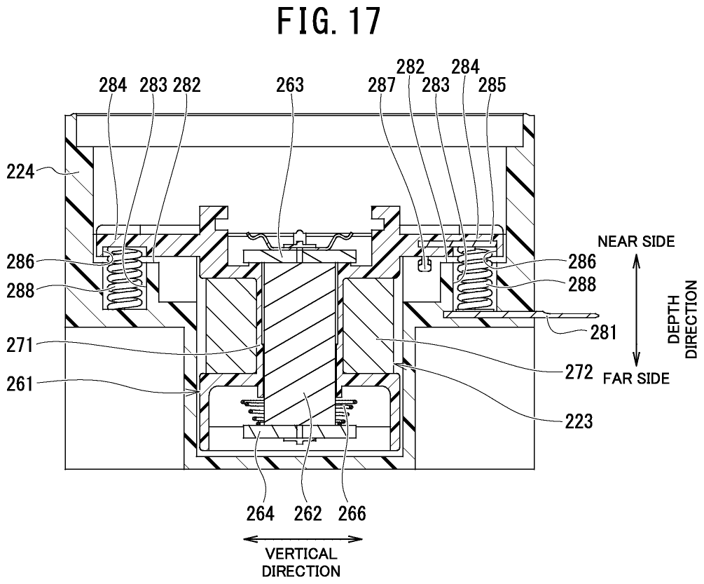

FIG. 17 is a cross-sectional view of a coil contact piece (the third embodiment).

In this drawing, a cross section passing a coil contact piece 281 and taken along the vertical direction and the depth direction is illustrated.

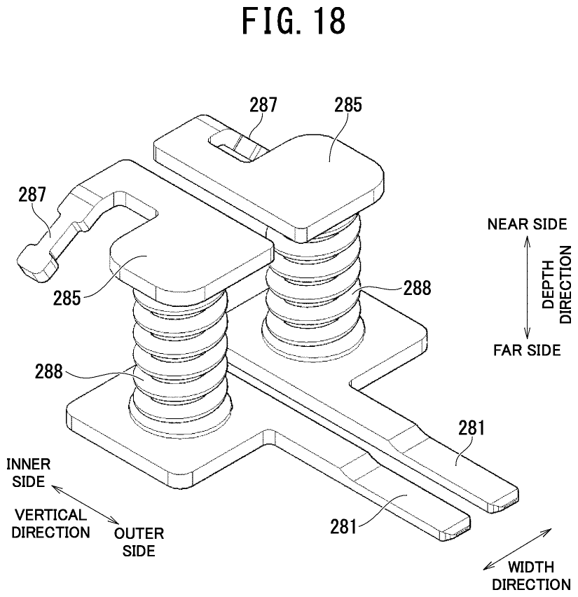

A pair of coil contact pieces 281 are made of a metal having conductivity, are formed in plate shapes aligned with the vertical direction and the width direction, and are arranged in parallel with a gap interposed therebetween in the width direction (see FIG. 18). One of the coil contact pieces 281 has the inner side in the vertical direction arranged inside the hermetically sealed container 215 and the outer side in the vertical direction connected to the positive side of a control circuit outside the hermetically sealed container 215. The other of the coil contact pieces 281 has the inner side in the vertical direction arranged inside the hermetically sealed container 215 and the outer side in the vertical direction connected to the negative side of the control circuit outside the hermetically sealed container 215. The pair of coil contact pieces 281 are integrated with the container portion 224 in such a manner as to penetrate through a sidewall of container portion 224 by insert molding. As for a method of insert molding, the same method as that used for the afore-described main fixed contact pieces 231 can be used.

On the inner peripheral surface of the container portion 224, a step-shaped spool receiving portion 282 is formed on each of both end sides in the vertical direction. On each of the spool receiving portions 282, two deep recessed portions 283, each of which is recessed toward the far side in the depth direction, are formed on a surface on the near side in the depth direction. A pair of deep recessed portions 283 are arranged in parallel with a gap interposed therebetween in the width direction, and, on one side in the vertical direction, the inner sides in the vertical direction of the coil contact pieces 281 are exposed by the deep recessed portions 283. The front surfaces of the coil contact pieces 281 that are exposed on one side in the vertical direction and the bottom surfaces of the deep recessed portions 283 formed on the other side in the vertical direction are located at the same position in the depth direction.

On the spool 261, an arm piece 284, which projects toward the outer side in the vertical direction, is formed on the near side in the depth direction and each of both sides in the vertical direction (see FIG. 14). Each of the arm pieces 284 is formed in a substantially plate shape aligned with the vertical direction and the width direction and serves as a cantilever. On one side in the vertical direction, a pair of relay contact pieces 285 are insert-molded in the arm piece 284 (see FIG. 18). The pair of relay contact pieces 285 are made of a metal having conductivity and are formed in plate shapes aligned with the vertical direction and the width direction. Since the relay contact pieces 285 are not components that penetrate through the hermetically sealed container 215, the method of insert molding does not require a special metal surface treatment technology as in a case of the afore-described main fixed contact pieces 231.

On each of the arm pieces 284, two shallow recessed portions 286, each of which is recessed toward the near side in the depth direction, are formed on a surface on the far side in the depth direction. Each pair of shallow recessed portions 286 are arranged in parallel with a gap interposed therebetween in the width direction, and, on one side in the vertical direction, the outer sides in the vertical direction of the relay contact pieces 285 are exposed by the shallow recessed portions 286. The front surfaces of the relay contact pieces 285 that are exposed on one side in the vertical direction and the bottom surfaces of the shallow recessed portions 286 formed on the other side in the vertical direction are located at the same position in the depth direction. On each of the relay contact pieces 285, a projecting portion 287, which projects from an end portion on the inner side in the vertical direction toward the outer side in the width direction, is formed (see FIG. 18). Each of the projecting portions 287 projects from a side surface in the width direction of the arm piece 284 and is inclined to the far side in the depth direction. To one of the projecting portions 287, one end of a winding wire of the coil 272 is soldered, and, to the other of the projecting portions 287, the other end of the winding wire of the coil 272 is soldered.

In each of the deep recessed portions 283 and corresponding one of the shallow recessed portions 286, a support spring 288 (spring member) is housed. Each of the support springs 288 has a feature that free height when no load is applied in the compression direction is greater than a dimension obtained by adding depth of a shallow recessed portion 286 to depth of a deep recessed portion 283. Although, when all the components are housed in the hermetically sealed container 215, a load in the compression direction is applied to the support springs 288, the support springs 288 are set to keep the arm pieces 284 separated upward from the spool receiving portion 282 even on this occasion (see FIG. 15). Therefore, the spool 261 has the pair of arm pieces 284 suspended on two pairs of support springs 288, each pair of which is disposed on one side. When the lid portion 225 is fixed to the container portion 224, the spool 261 being pressed to the pair of main fixed contact pieces 231 via the partition wall member 254 due to repulsive force of the support springs 288 causes backlash to be suppressed.

FIG. 18 is a diagram illustrative of the coil contact pieces, the support springs, and the relay contact pieces (the third embodiment).

In this drawing, a configuration in which only the coil contact pieces 281, the relay contact pieces 285, and the support springs 288 are picked out and the container portion 224, the arm pieces 284, and the spool receiving portions 282 are omitted is illustrated. The support springs 288 are made of a metal having conductivity. On one side in the vertical direction, the support springs 288 are sandwiched between the coil contact pieces 281 and the relay contact pieces 285 while being compressed, and the support springs 288 are in contact with both the coil contact pieces 281 and the relay contact pieces 285. This configuration causes the coil contact pieces 281 and the coil 272 to be electrically connected. Therefore, on the one side in the vertical direction, the support springs 288 serve as both a support of the spool 261 and an electrical connection for the coil contact pieces 281.

According to the above description, when the coil 272 is in a non-excited state in which no current is applied to the coil 272, the plunger 262 has retreated to the far side in the depth direction due to repulsive force of the return spring 266 and, in association therewith, the contact support 251 also retreats to the far side in the depth direction. Because of this configuration, the main contact unit 221 is opened and, at the same time, the auxiliary contact unit 222 is closed. On this occasion, the upper armature 263 is separated from the upper piece portions 274, and the lower armature 264 is separated from the lower piece portions 275.

When, while the coil 272 is in this state, current is applied to the coil 272 and the coil 272 is excited, the upper armature 263 is attracted and stuck to the upper piece portions 274 and, at the same time, the lower armature 264 is attracted and stuck to the lower piece portions 275. Therefore, the plunger 262 advances to the near side in the depth direction against the repulsive force of the return spring 266 and, in association therewith, the contact support 251 also advances to the near side in the depth direction. Because of this configuration, the main contact unit 221 is closed and, at the same time, the auxiliary contact unit 222 is opened.

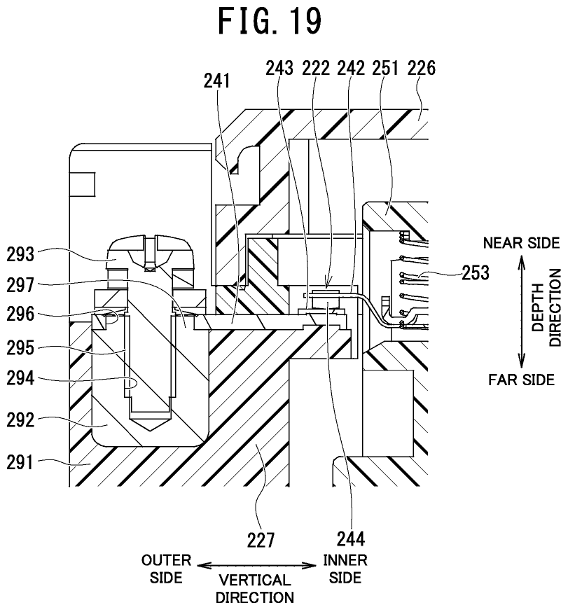

FIG. 19 is a cross-sectional view of the auxiliary contact unit (the third embodiment).

In this drawing, a cross section passing the center in the width direction and taken along the vertical direction and the depth direction is illustrated.

On the small cylinder portion 227, terminal receiving portions 291 are formed on the back surface side, that is, on the far side in the depth direction, of the auxiliary fixed contact pieces 241, which are located on the outer sides in the vertical direction of the small cylinder portion 227. Each of the terminal receiving portions 291 is a portion projecting from a sidewall of the small cylinder portion 227 toward the outer side in the vertical direction, and a nut member 292 is integrated with the terminal receiving portion 291 by insert molding. Each of the nut members 292 is made of a metal having conductivity and is formed in a cylindrical shape, and, on the near side in the depth direction, a bottomed threaded hole 294, into which a terminal screw 293 is fitted, is formed in the depth direction. As for a method of insert molding, the same method as that used for the afore-described main fixed contact pieces 231 can be used.

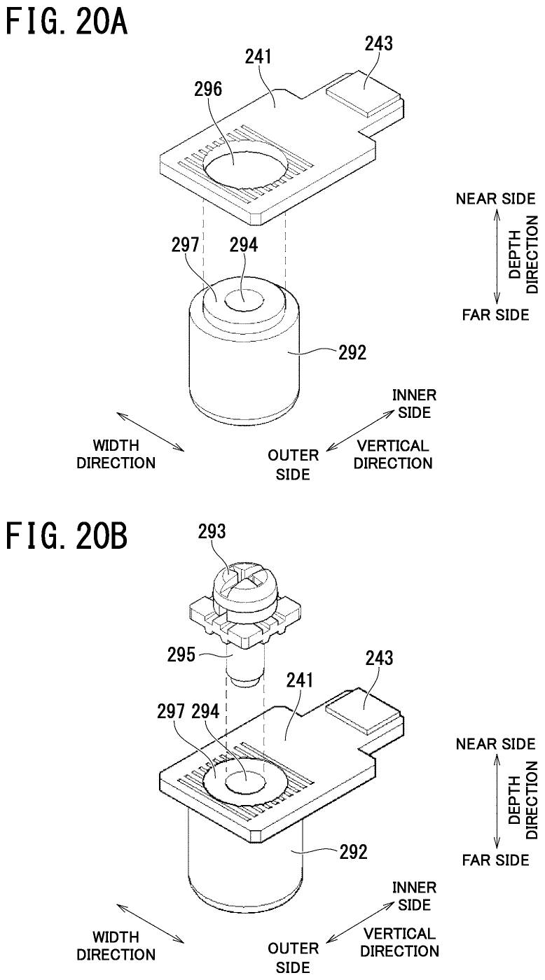

FIGS. 20A-20B are diagrams illustrative of the nut member (the third embodiment).

FIG. 20A illustrates fitting between a nut member 292 and an auxiliary fixed contact piece 241, and FIG. 20B illustrates fitting between the nut member 292 and a terminal screw 293. In the auxiliary fixed contact piece 241, a circular hole 296 (insertion hole), which has a larger diameter than the outer diameter of an external threaded portion 295 on the terminal screw 293, is formed on the other end side, which is located outside the small cylinder portion 227, and, on the nut member 292, a small-diameter portion 297, which fits into the circular hole 296, is formed on the near side in the depth direction. Height in the depth direction of the small-diameter portion 297 is the same as plate thickness of the auxiliary fixed contact piece 241. To the terminal screw 293, a square washer for wire holding and a spring washer are attached.

### Advantageous Effects

Next, main advantageous effects of the third embodiment will be described.

Although hermetically sealed containers, which house a main contact unit and an auxiliary contact unit, have been hitherto containers made of metal and covered by a lid made of ceramic, there has been a limit to miniaturization and weight reduction and a degree of freedom in design. Accordingly, in the present embodiment, the main contact unit 221, the auxiliary contact unit 222, and the electromagnet unit 223 are arranged inside the hermetically sealed container 215, which is made of resin, and the hermetically sealed container 215 is filled with pressurized insulating gas. Using the hermetically sealed container 215 made of resin enables not only miniaturization and weight reduction to be achieved but also a degree of freedom in design to be improved. In addition, by arranging the main contact unit 221 and the auxiliary contact unit 222 in the hermetically sealed container 215 and causing the hermetically sealed container 215 to be filled with insulating gas, which improves breaking performance, it is possible to prevent an arc-extinguishing space from becoming larger in size.

To the hermetically sealed container 215, gas barrier coating is applied using laminated films of clay crystals. This configuration can suppress permeation of gas molecules, such as hydrogen and nitrogen, and thereby prevent leakage of pressurized insulating gas.

The main contact unit 221 includes the pair of main fixed contact pieces 231 and the main movable contact piece 232. The main fixed contact pieces 231 have the main fixed contacts 233 at one ends, and the other ends serve as main terminal portions to be connected to the main circuit. The main movable contact piece 232 has the pair of main movable contacts 234, which come into contact with and are separated from the main fixed contacts 233. The auxiliary contact unit 222 includes the pair of auxiliary fixed contact pieces 241 and the auxiliary movable contact piece 242. The pair of auxiliary fixed contact pieces 241 have the auxiliary fixed contacts 243 at one ends, and the other end sides serve as auxiliary terminal portions to be connected to the auxiliary circuit. The auxiliary movable contact piece 242 has the pair of auxiliary movable contacts 244, which come into contact with and are separated from the auxiliary fixed contacts 243. The main movable contact piece 232 and the auxiliary movable contact piece 242 are long flat plates and have the main movable contacts 234 and the auxiliary movable contacts 244 at both ends in the long-length direction, respectively. This configuration enables opening/closing of the main contact unit 221 and opening/closing of the auxiliary contact unit 222 to be easily switched.

The pair of auxiliary fixed contact pieces 241 are arranged with a gap interposed between one end sides thereof inside the hermetically sealed container 215, the auxiliary fixed contact 243 is formed on one end side of each of the auxiliary fixed contact pieces 241, and the other end side of each of the auxiliary fixed contact pieces 241 is connected to the auxiliary circuit outside the hermetically sealed container 215. The auxiliary movable contact piece 242 has the auxiliary movable contacts 244 formed on both end sides and causes the auxiliary movable contacts 244 to respectively come into contact with and be separated from the auxiliary fixed contacts 243. The auxiliary contact unit 222 is formed by the auxiliary fixed contacts 243 and the auxiliary movable contacts 244. The pair of auxiliary fixed contact pieces 241 are subjected to surface treatment by chemical etching and are integrated with the hermetically sealed container 215 by insert molding. This processing causes the metal and the resin to be joined at the interface level and produces complex junctions exhibiting labyrinth effect, which enables gas molecules, such as hydrogen and nitrogen, to be prevented from leaking.

Each of the pair of auxiliary fixed contact pieces 241 is formed in a flat plate shape, and the circular hole 296, which has a larger diameter than the outer diameter of the external threaded portion 295 on the terminal screw 293, is formed on the other end side, which is located outside the hermetically sealed container 215. On the hermetically sealed container 215, the terminal receiving portions 291 are formed on the back surface side of the auxiliary fixed contact pieces 241, which are located outside the hermetically sealed container 215, and, on the terminal receiving portions 291, the nut members 292, which are made of metal, in each of which the bottomed threaded hole 294, into which the terminal screw 293 fits, is formed are disposed. Each of the nut members 292 is subjected to surface treatment by chemical etching and is integrated with the terminal receiving portion 291 by insert molding. This processing causes the metal and the resin to be joined at the interface level and produces complex junctions exhibiting labyrinth effect, which enables gas molecules, such as hydrogen and nitrogen, to be prevented from leaking.

The pair of main fixed contact pieces 231 are linear flat plates and are arranged in series with a gap interposed therebetween in the vertical direction. This configuration enables the hermetically sealed container 215 to be prevented from becoming larger in size in the depth direction. Since, when the main contact unit 221 is closed, the main movable contact piece 232 pushes the main fixed contact pieces 231 to the near side in the depth direction, strength is secured by disposing the pair of main fixed contact pieces 231 in such a manner that the main fixed contact pieces 231 come into contact with the ceiling surface, that is, the inner peripheral surface, of the lid portion 225. Such a layout enables a sufficient space to be secured on the upper surface of the lid portion 225. Therefore, when viewed from the depth direction, the main movable contact piece 232 and the auxiliary movable contact piece 242 can be arranged in such a manner that the long-length directions thereof are the same as each other, and the auxiliary movable contact piece 242 can be arranged in such a manner that the long-length direction thereof is parallel with the vertical direction of the hermetically sealed container 215. Employing a simple structure as described above enables competition for a space to be prevented, the auxiliary contact unit 222 to be easily arranged, and cost to be prevented from increasing.

When a configuration in which the nut member 292 is omitted, an internal threaded portion is formed in the circular hole 296 of the auxiliary fixed contact piece 241, and the terminal screw 293 is fitted into the internal threaded portion is employed, a threaded hole into which the external threaded portion 295 of the terminal screw 293 enters needs to be formed in the terminal receiving portion 291. This threaded hole has a larger diameter than the external threaded portion 295 of the terminal screw 293. Since it is required to apply gas barrier coating to the entire outer peripheral surface of the hermetically sealed container 215, gas barrier coating also needs to be applied to the inner peripheral surface of the threaded hole formed in the terminal receiving portion 291. However, since the auxiliary fixed contact piece 241 is disposed at the open end of the threaded hole, it is difficult to apply gas barrier coating to the inner peripheral surface of the threaded hole by spray method. Thus, by insert-molding the nut member 292 made of metal as described above, leakage of gas molecules, such as hydrogen and nitrogen, is prevented.

The pair of main fixed contact pieces 231 are arranged with a gap interposed between one end sides thereof inside the hermetically sealed container 215, the main fixed contact 233 is formed on one end side of each of the main fixed contact pieces 231, and the other end side of each of the main fixed contact pieces 231 is connected to the main circuit outside the hermetically sealed container 215. In addition, the main movable contact piece 232 has the main movable contacts 234 formed on both end sides and causes the main movable contacts 234 to respectively come into contact with and be separated from the main fixed contacts 233. The main contact unit 221 is formed by the main fixed contacts 233 and the main movable contacts 234. The pair of main fixed contact pieces 231 are subjected to surface treatment by chemical etching and are integrated with the hermetically sealed container 215 by insert molding. This processing causes the metal and the resin to be joined at the interface level and produces complex junctions exhibiting labyrinth effect, which enables gas molecules, such as hydrogen and nitrogen, to be prevented from leaking.

Each of coil contact pieces 281 has one end side arranged inside the hermetically sealed container 215, and the other end side of the coil contact piece 281 is connected to the control circuit outside the hermetically sealed container 215. The relay contact pieces 285 are fixed to the spool 261 of the electromagnet unit 223, and the coil 272 of the electromagnet unit 223 is connected to the relay contact pieces 285. The support springs 288 are made of metal and are sandwiched between the coil contact pieces 281 and the relay contact pieces 285 inside the hermetically sealed container 215. Because of this configuration, it is possible to maintain an excellent contact state between the coil contact pieces 281 and the relay contact pieces 285 by expansion and contraction of the support springs 288 even in an environment in which the electromagnetic contactor is vibrated, which enables reliability of the product to be improved. The coil contact pieces 281 are subjected to surface treatment by chemical etching and are integrated with the hermetically sealed container 215 by insert molding. This processing causes the metal and the resin to be joined at the interface level and produces complex junctions exhibiting labyrinth effect, which enables gas molecules, such as hydrogen and nitrogen, to be prevented from leaking.

The support springs 288 press the electromagnet unit 223 to the hermetically sealed container 215. Specifically, when the lid portion 225 is fixed to the container portion 224, the spool 261 is pressed to the pair of main fixed contact pieces 231 via the partition wall member 254 due to repulsive force of the support springs 288. This configuration can prevent backlash from occurring to the electromagnet unit 223 and the partition wall member 254 inside the hermetically sealed container 215. Two support springs 288 on one side and two support springs 288 on the other side in the vertical direction, that is, in total, four support springs 288 are disposed, and are arranged in such a way that repulsive force equally acts on both sides in the vertical direction of the spool 261. Because of this configuration, deviation of the center of gravity is reduced and stability is improved. In addition, workability when the hermetically sealed container 215 is assembled is also improved.

While the present invention has been described with reference to the definite number of embodiments, the scope of the present invention is not limited thereto and improvements and modifications of the embodiments based on the above disclosure are obvious to a person skilled in the art.

### REFERENCE SIGNS LIST

11 Hermetically sealed container
12 Container body
13 Auxiliary contact housing portion
14 Container portion
15 Lid portion
16 Gas filling structure
17 Opening portion
18 Recessed portion
21 Main contact unit
22 Auxiliary contact unit
23 Electromagnet unit
31 Main fixed contact piece
32 Main movable contact piece
33 Side plate portion
34 Upper plate portion
35 Lower plate portion
36 Main fixed contact
37 Terminal bolt
38 Main movable contact
41 Auxiliary fixed contact piece
42 Auxiliary movable contact piece
43 Lower plate portion
44 Side plate portion
46 Auxiliary fixed contact
47 Recessed portion
48 Auxiliary movable contact
51 Contact support
52 Main contact spring
53 Auxiliary contact spring
54 Partition wall member
55 Permanent magnet
56 Yoke
61 Spool
62 Plunger
63 Upper armature
64 Lower armature
65 Yoke
66 Return spring
71 Winding shaft
72 Coil
73 Side piece portion
74 Upper piece portion
75 Lower piece portion
81 Coil contact piece
82 Spool receiving portion
83 Deep recessed portion
84 Arm piece
85 Relay contact piece
86 Shallow recessed portion
87 Projecting portion
88 Support spring
111 Hermetically sealed container
112 Container body
113 Auxiliary contact housing portion
114 Container portion
115 Lid portion
117 Opening portion
118 Recessed line portion
121 Main contact unit
122 Auxiliary contact unit
126 Pedestal portion
127 Recessed portion
128 Recessed portion
131 Main fixed contact piece
132 Main movable contact piece
136 Main fixed contact
138 Main movable contact
141 Auxiliary fixed contact piece
141a Upper plate portion
141b Inner-side plate portion
141c Lower plate portion
141d Outer-side plate portion
142 Auxiliary movable contact piece
146 Auxiliary fixed contact
148 Auxiliary movable contact
151 Contact support
152 Main contact spring
153 Auxiliary contact spring
154 Partition wall member
155 Permanent magnet
156 Yoke
211 Hermetically sealed electromagnetic contactor
212 Case
213 Main terminal cover
214 Auxiliary terminal cover
215 Hermetically sealed container
216 Resin nut
221 Main contact unit
222 Auxiliary contact unit
223 Electromagnet unit
224 Container portion
225 Lid portion
226 Cap portion
227 Small cylinder portion
231 Main fixed contact piece
232 Main movable contact piece
233 Main fixed contact
234 Main movable contact
241 Auxiliary fixed contact piece
242 Auxiliary movable contact piece
243 Auxiliary fixed contact
244 Auxiliary movable contact
251 Contact support
252 Main contact spring
253 Auxiliary contact spring
254 Partition wall member
261 Spool
262 Plunger
263 Upper armature
264 Lower armature
265 Yoke
266 Return spring
271 Winding shaft
272 Coil
273 Side piece portion
274 Upper piece portion
275 Lower piece portion
281 Coil contact piece
282 Spool receiving portion
283 Deep recessed portion
284 Arm piece
285 Relay contact piece
286 Shallow recessed portion
287 Projecting portion
288 Support spring
291 Terminal receiving portion
292 Nut member
293 Terminal screw
294 Threaded hole
295 External threaded portion
296 Circular hole
297 Small-diameter portion

1. A hermetically sealed electromagnetic contactor comprising:
a main contact unit configured to open and close an electrical path of a main circuit by moving along a predetermined opening/closing direction;
an electromagnet unit configured to switch opening/closing of the main contact unit;
a container body made of resin inside which the main contact unit and the electromagnet unit are arranged;
an auxiliary contact unit disposed outside the container body on one side in the opening/closing direction of the main contact unit and configured to open and close an electrical path of an auxiliary circuit by moving along the opening/closing direction in conjunction with the main contact unit; and
an auxiliary contact housing portion made of resin inside which the auxiliary contact unit is arranged, the auxiliary contact housing portion communicating with an inside of the container body,
wherein insides of the container body and the auxiliary contact housing portion are filled with insulating gas.

2. The hermetically sealed electromagnetic contactor according to claim 1, wherein
in the container body, an opening portion is formed on one side in the opening/closing direction, and
the hermetically sealed electromagnetic contactor comprises a contact support capable of advancing and retreating in the opening/closing direction and configured to have a base end side supporting a movable side of the main contact unit inside the container body and a tip end side passing the opening portion and supporting a movable side of the auxiliary contact unit inside the auxiliary contact housing portion.

3. The hermetically sealed electromagnetic contactor according to claim 2, wherein the auxiliary contact housing portion covers a tip end side of the contact support and hermetically seals the opening portion.

4. The hermetically sealed electromagnetic contactor according to claim 2, wherein the auxiliary contact housing portion is bonded to the container body with adhesive.

5. The hermetically sealed electromagnetic contactor according to claim 1, wherein
the main contact unit includes:
a pair of main fixed contact pieces, each of the main fixed contact pieces having a main fixed contact at one end and a main terminal portion to be connected to the main circuit at another end; and
a main movable contact piece having a pair of main movable contacts, the main movable contacts coming into contact with and being separated from the main fixed contacts,
the auxiliary contact unit includes:
a pair of auxiliary fixed contact pieces, each of the auxiliary fixed contact pieces having an auxiliary fixed contact at one end and an auxiliary terminal portion to be connected to the auxiliary circuit at another end; and
an auxiliary movable contact piece having a pair of auxiliary movable contacts, the auxiliary movable contacts coming into contact with and being separated from the auxiliary fixed contacts, and
the main movable contact piece and the auxiliary movable contact piece are long flat plates and have the main movable contacts and the auxiliary movable contacts at both ends in a long-length direction, respectively.

6. The hermetically sealed electromagnetic contactor according to claim 5, wherein the pair of main fixed contact pieces and the pair of auxiliary fixed contact pieces are subjected to surface treatment by chemical etching and are integrated with the container body and the auxiliary contact housing portion by insert molding, respectively.

7. The hermetically sealed electromagnetic contactor according to claim 5, wherein long-length directions of the main movable contact piece and the auxiliary movable contact piece are same as each other.

8. The hermetically sealed electromagnetic contactor according to claim 5, wherein
the pair of main fixed contact pieces formed in substantially U-shapes are disposed in such a manner that openings of the U-shapes face each other in a long-length direction of the main movable contact piece, and
long-length directions of the main movable contact piece and the auxiliary movable contact piece are orthogonal to each other.

9. The hermetically sealed electromagnetic contactor according to claim 5, wherein
the auxiliary terminal portion is a terminal screw,
each of the pair of auxiliary fixed contact pieces is formed in a flat plate shape and an insertion hole larger than outer diameter of an external threaded portion on the terminal screw is formed on another end side of the auxiliary fixed contact piece, the another end side being located outside the container body,
on the container body, terminal receiving portions are formed on a back surface side of the auxiliary fixed contact pieces located outside the container body,
in each of the terminal receiving portions, a nut member made of metal in which a bottomed threaded hole, into which the terminal screw is fitted, is formed is disposed, and
the nut members are subjected to surface treatment by chemical etching and are integrated with the terminal receiving portions by insert molding.

10. The hermetically sealed electromagnetic contactor according to claim 1 comprising:
a coil contact piece having one end side arranged inside the container body and another end side connected to a control circuit outside the container body;
a relay contact piece to which a coil of the electromagnet unit is connected, the relay contact piece being fixed to a spool of the electromagnet unit; and
a spring member made of metal and sandwiched between the coil contact piece and the relay contact piece inside the container body,
wherein the coil contact piece is subjected to surface treatment by chemical etching and is integrated with the container body by insert molding.

11. The hermetically sealed electromagnetic contactor according to claim 10, wherein the spring member presses the electromagnet unit to the container body.

12. The hermetically sealed electromagnetic contactor according to claim 1, wherein, to the container body and the auxiliary contact housing portion, gas barrier coating is applied using laminated films of clay crystals.

13. The hermetically sealed electromagnetic contactor according to claim 3, wherein the auxiliary contact housing portion is bonded to the container body with adhesive.

14. The hermetically sealed electromagnetic contactor according to claim 2, wherein
the main contact unit includes:
a pair of main fixed contact pieces, each of the main fixed contact pieces having a main fixed contact at one end and a main terminal portion to be connected to the main circuit at another end; and
a main movable contact piece having a pair of main movable contacts, the main movable contacts coming into contact with and being separated from the main fixed contacts,
the auxiliary contact unit includes:
a pair of auxiliary fixed contact pieces, each of the auxiliary fixed contact pieces having an auxiliary fixed contact at one end and an auxiliary terminal portion to be connected to the auxiliary circuit at another end; and
an auxiliary movable contact piece having a pair of auxiliary movable contacts, the auxiliary movable contacts coming into contact with and being separated from the auxiliary fixed contacts, and
the main movable contact piece and the auxiliary movable contact piece are long flat plates and have the main movable contacts and the auxiliary movable contacts at both ends in a long-length direction, respectively.

15. The hermetically sealed electromagnetic contactor according to claim 3, wherein
the main contact unit includes:
a pair of main fixed contact pieces, each of the main fixed contact pieces having a main fixed contact at one end and a main terminal portion to be connected to the main circuit at another end; and
a main movable contact piece having a pair of main movable contacts, the main movable contacts coming into contact with and being separated from the main fixed contacts,
the auxiliary contact unit includes:
a pair of auxiliary fixed contact pieces, each of the auxiliary fixed contact pieces having an auxiliary fixed contact at one end and an auxiliary terminal portion to be connected to the auxiliary circuit at another end; and
an auxiliary movable contact piece having a pair of auxiliary movable contacts, the auxiliary movable contacts coming into contact with and being separated from the auxiliary fixed contacts, and
the main movable contact piece and the auxiliary movable contact piece are long flat plates and have the main movable contacts and the auxiliary movable contacts at both ends in a long-length direction, respectively.

16. The hermetically sealed electromagnetic contactor according to claim 4, wherein
the main contact unit includes:
a pair of main fixed contact pieces, each of the main fixed contact pieces having a main fixed contact at one end and a main terminal portion to be connected to the main circuit at another end; and
a main movable contact piece having a pair of main movable contacts, the main movable contacts coming into contact with and being separated from the main fixed contacts,
the auxiliary contact unit includes:
a pair of auxiliary fixed contact pieces, each of the auxiliary fixed contact pieces having an auxiliary fixed contact at one end and an auxiliary terminal portion to be connected to the auxiliary circuit at another end; and
an auxiliary movable contact piece having a pair of auxiliary movable contacts, the auxiliary movable contacts coming into contact with and being separated from the auxiliary fixed contacts, and
the main movable contact piece and the auxiliary movable contact piece are long flat plates and have the main movable contacts and the auxiliary movable contacts at both ends in a long-length direction, respectively.

17. The hermetically sealed electromagnetic contactor according to claim 6, wherein long-length directions of the main movable contact piece and the auxiliary movable contact piece are same as each other.

18. The hermetically sealed electromagnetic contactor according to claim 6, wherein
the pair of main fixed contact pieces formed in substantially U-shapes are disposed in such a manner that openings of the U-shapes face each other in a long-length direction of the main movable contact piece, and
long-length directions of the main movable contact piece and the auxiliary movable contact piece are orthogonal to each other.

19. The hermetically sealed electromagnetic contactor according to claim 6, wherein
the auxiliary terminal portion is a terminal screw,
each of the pair of auxiliary fixed contact pieces is formed in a flat plate shape and an insertion hole larger than outer diameter of an external threaded portion on the terminal screw is formed on another end side of the auxiliary fixed contact piece, the another end side being located outside the container body,
on the container body, terminal receiving portions are formed on a back surface side of the auxiliary fixed contact pieces located outside the container body,
in each of the terminal receiving portions, a nut member made of metal in which a bottomed threaded hole, into which the terminal screw is fitted, is formed is disposed, and
the nut members are subjected to surface treatment by chemical etching and are integrated with the terminal receiving portions by insert molding.

20. The hermetically sealed electromagnetic contactor according to claim 7, wherein
the auxiliary terminal portion is a terminal screw,
each of the pair of auxiliary fixed contact pieces is formed in a flat plate shape and an insertion hole larger than outer diameter of an external threaded portion on the terminal screw is formed on another end side of the auxiliary fixed contact piece, the another end side being located outside the container body,
on the container body, terminal receiving portions are formed on a back surface side of the auxiliary fixed contact pieces located outside the container body,
in each of the terminal receiving portions, a nut member made of metal in which a bottomed threaded hole, into which the terminal screw is fitted, is formed is disposed, and
the nut members are subjected to surface treatment by chemical etching and are integrated with the terminal receiving portions by insert molding.
